(19) United States
(12) Patent Application Publication
(10) Pub. No.: US 2026/0352038 A1
(43) Pub. Date: Nov. 5, 2026

(54) ELECTRONIC DEVICE, METHOD OF OPERATING THE SAME, AND WIRELESS CHARGING SYSTEM

(71) Applicant: Samsung Electronics Co., Ltd., Suwon-si (KR)

(72) Inventors: HYUNSU KIM, Suwon-si (KR); HYOUNGSEOK OH, Suwon-si (KR)

(21) Appl. No.: 19/427,842

(22) Filed: Dec. 19, 2025

(30) Foreign Application Priority Data
Apr. 30, 2025 (KR) 10-2025-0057534

(51) Int. Cl. H02J 50/90; H02J 50/12; H02J 50/80

(52) U.S. Cl. CPC H02J 50/90; H02J 50/12; H02J 50/80

(57) ABSTRACT

A wireless charging system including an electronic device and a method of operating the electronic device, the electronic device including an LC circuit including a coil and a first capacitor, and configured to receive a power signal through induction of the coil, a rectifier circuit configured to generate a DC voltage and a DC current based on the power signal, a regulator circuit configured to perform a conversion operation based on the DC voltage and the DC current to generate an output voltage, an impedance control circuit disposed between the rectifier circuit and the regulator circuit, and configured to perform an operation of changing the DC current, and a coupling coefficient estimator configured to calculate an estimated coupling coefficient value between the coil and an external coil, based on the DC current and a load impedance corresponding to the DC current.

### CROSS-REFERENCE TO RELATED APPLICATION

This application claims priority under 35 U.S.C. § 119 to and the benefit thereof Korean Patent Application No. 10-2025-0057534 filed on Apr. 30, 2025, in the Korean Intellectual Property Office, the entire contents of which are incorporated herein by reference.

### BACKGROUND OF THE DISCLOSURE

### (a) Field

The present disclosure relates to an electronic device, a method of operating the same, and a wireless charging system.

### (b) Description of the Related Art

As electronic devices are utilized in various fields, charging technologies for supplying power to electronic devices are being researched in various ways, and a wireless charging method that charges an electronic device without connecting a separate charging connector is also being researched. Wireless charging technology uses wireless power transmission and reception, and as an example, there is a system in which the battery of an electronic device can be automatically charged just by placing it on a charging pad.

Wireless charging technology includes an electromagnetic induction method, a resonance method using resonance, or a radio wave radiation (RF/microwave radiation) method that converts electrical energy into microwaves and transmits it.

Wireless charging technology based on the electromagnetic induction method, or the resonance method, is a method of transmitting power between a coil of a transmitter device and a coil of a receiver device. The transmitter device generates a magnetic field, and the receiver device generates energy by inducing or resonating current based on the change in the magnetic field.

However, if the alignment between the coil of the transmitter device and the coil of the receiver device is not good, the coupling coefficient between the coils becomes low, which lowers AC efficiency and causes heat generation, and the degradation of charging efficiency occurs due to heat generation and the like.

### SUMMARY OF THE DISCLOSURE

Some embodiments provide an electronic device, a method of operating the electronic device, and a wireless charging system that cost-effectively induce optimal alignment between a coil of a power transmitter device and a coil of a power receiver device.

Some embodiments provide an electronic device, a method of operating the electronic device, and a wireless charging system that easily estimate the coupling coefficient between a coil of a power transmitter device and a coil of a power receiver device according to the situation.

According to a disclosed embodiment, an electronic device includes an LC circuit including a coil and a first capacitor, and configured to receive a power signal through induction of the coil, a rectifier circuit configured to generate a DC voltage and a DC current based on the power signal, a regulator circuit configured to perform a conversion operation based on the DC voltage and the DC current to generate an output voltage, an impedance control circuit disposed between the rectifier circuit and the regulator circuit, and configured to perform an operation of changing the DC current, and a coupling coefficient estimator configured to calculate an estimated coupling coefficient value between the coil and an external coil, based on the DC current and a load impedance corresponding to the DC current.

According to a disclosed embodiment, a method of operating an electronic device includes: detecting an approach of an external electronic device based on a ping phase, performing a rectification operation on a power signal received from the external electronic device to generate a DC current flowing to a rectification node of the electronic device and a DC voltage applied to the rectification node, sending a control error packet to the external electronic device to maintain a reception condition for the power signal received by an LC circuit of the electronic device from the external electronic device, changing the DC current to measure a plurality of load impedances at an output terminal of the LC circuit, calculating an estimated coupling coefficient value between an external coil in the external electronic device and an internal coil in the LC circuit, based on the plurality of load impedances, comparing the estimated coupling coefficient value with a threshold value, and sending negative feedback about an alignment between the external coil and the internal coil to a user interface of the electronic device in response to the estimated coupling coefficient value being smaller than the threshold value.

According to a disclosed embodiment, a wireless charging system includes a first electronic device including a power source configured to provide an input voltage, a first LC circuit including a first coil and a first capacitor and configured to transmit a first power signal corresponding to the input voltage through induction of the first coil, and a demodulation circuit configured to generate a demodulated signal including a data packet for the first power signal, and a second electronic device including a second LC circuit including a second coil and a second capacitor and configured to receive a second power signal corresponding to the first power signal through mutual induction of the first coil and the second coil, a rectifier circuit configured to generate a DC voltage and a DC current based on the second power signal, an impedance control circuit configured to perform an operation of changing the DC current, a controller configured to generate a control error packet requesting maintenance of the input voltage before the operation of changing the DC current, and a modulation circuit configured to perform a modulation operation on the control error packet using the second power signal.

According to a disclosed embodiment, a method of operating an electronic device includes: detecting an approach of an external electronic device based on a ping phase, receiving a control error packet from the external electronic device to maintain a transmission condition for a power signal transmitted to the external electronic device through an LC circuit of the electronic device, receiving an estimated coupling coefficient value between an external coil in the external electronic device and an internal coil in the LC circuit, comparing the estimated coupling coefficient value with a threshold value, and moving the internal coil, in response to the estimated coupling coefficient value being smaller than the threshold value.

According to a disclosed embodiment, an electronic device includes a pad unit including a coil and a capacitor, and configured to transmit a power signal, which is an AC signal, through induction of the coil, an inverter circuit configured to receive an input voltage, which is a DC voltage, from a power source, and generate the power signal based on the input voltage, a demodulation circuit configured to demodulate a voltage applied across both ends of the coil to generate the demodulated signal, and a controller configured to receive a control error packet for the input voltage and an estimated coupling coefficient value for the coil from an external device through the demodulated signal, maintain the input voltage based on the control error packet, and move the coil within the pad unit based on the estimated coupling coefficient value.

### BRIEF DESCRIPTION OF THE DRAWINGS

FIG. 1 is a block diagram illustrating a wireless charging system according to some example embodiments.

FIG. 2 is a block diagram illustrating a PMIC (power management integrated circuit) according to some example embodiments.

FIG. 3 is a drawing illustrating an example of an electronic device in a wireless charging system according to some example embodiments.

FIG. 4 is a circuit diagram illustrating a wireless charging system according to some example embodiments.

FIG. 5 is a drawing modeling a wireless charging system in the frequency domain according to some example embodiments.

FIG. 6 and FIG. 7 are drawings for explaining a received power signal according to some example embodiments.

FIG. 8 is a flowchart illustrating a method of operating an electronic device according to some example embodiments.

FIG. 9, FIG. 10, and FIG. 11 are drawings for explaining a method of operating an electronic device according to some example embodiments.

FIG. 12 is a timing diagram for explaining a method of operating an electronic device according to some example embodiments.

FIG. 13 is a timing diagram for explaining a method of operating an electronic device according to some example embodiments.

FIG. 14 is a flowchart illustrating a method of operating an electronic device according to some example embodiments.

FIG. 15 to FIG. 16 are drawings for explaining a method of operating an electronic device according to some example embodiments.

### DETAILED DESCRIPTION OF THE EMBODIMENTS

Hereinafter, various embodiments of the present disclosure will be described in detail with reference to the accompanying drawings so that those skilled in the art to which the present disclosure pertains can easily carry out the embodiments. The present disclosure may be embodied in many different forms and is not limited to the embodiments described herein. The present disclosure may be embodied in many different forms and is not limited to the embodiments described herein.

To clearly describe the present disclosure, parts irrelevant to the description are omitted, and the same or similar reference numerals are assigned to the same or similar components throughout the specification.

In addition, throughout the specification, when a certain part “includes” a certain component, it means that it can further include other components, rather than excluding other components, unless otherwise specifically stated.

In addition, a specific number recited in the claims should not be understood as a limitation of the specific number in a claim in which such recitation does not exist, even if it is explicitly cited within the claim. For example, for ease of understanding, the phrases ‘at least one’ and ‘one or more’ may be included in subsequent dependent claims. However, the use of such phrases should not be understood as a limitation by the indefinite article ‘a’ or ‘an’, which is described for one example.

Furthermore, when a convention such as ‘at least one of A, B, or C’ is used, this phrase will be well understood by a person skilled in the art (i.e., ‘a system including at least one of A, B, or C’ includes the meaning of A alone, B alone, C alone, A and B, A and C, B and C, and/or A, B, and C together, but is not limited to any one concept). Or, words and/or phrases having two or more separate selectable terms in the detailed description, claims, or drawings should be considered as having the possibility of including one, or either of the two, or both terms. For example, the phrase ‘A or B’ should be understood to include the possibility of ‘A’, or ‘B’, or ‘A and B’.

It will be understood that, although the terms first and/or primary, second and/or secondary, third and/or tertiary, etc. may be used herein to describe various elements, components, regions, layers and/or sections, these elements, components, regions, layers and/or sections should not be limited by these terms. Such terms may include, for example and without limitation, “first,” “primary first,” “secondary first,” “second,” “primary second,” “secondary second,” etc. Unless the context indicates otherwise, these terms are only used to distinguish one element, component, region, layer, or section from another element, component, region, layer or section, for example as a naming convention. In addition, in certain cases, even if a term is not described using first and/or primary, second and/or secondary, etc. in the specification, it may still be referred to as first and/or primary, second and/or secondary in a claim in order to distinguish different claimed elements from each other.

Terms such as “block,” “module,” “unit,” “part,” and the like used in this document are terms for referring to a component that performs at least one function or operation, and such a component may be implemented as hardware or software, or as a combination of hardware and software. Those skilled in the art will appreciate that these blocks, modules, units and/or parts are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, modules, units and/or parts being implemented by microprocessors or similar, they may be programmed using software (e.g., microcode) to perform various functions discussed herein and may optionally be driven by firmware and/or software. Alternatively, each block, module, unit and/or part may be implemented by dedicated hardware, or as a combination of dedicated hardware to perform some functions and a processor (e.g., one or more programmed microprocessors and associated circuitry) to perform other functions. Also, each block, module, unit and/or part of the embodiments may be physically separated into two or more interacting and discrete blocks, modules, units and/or parts without departing from the scope of the inventive concepts. Further, the blocks, modules, units and/or parts of the embodiments may be physically combined into more complex blocks, modules, units and/or parts without departing from the scope of the inventive concepts.

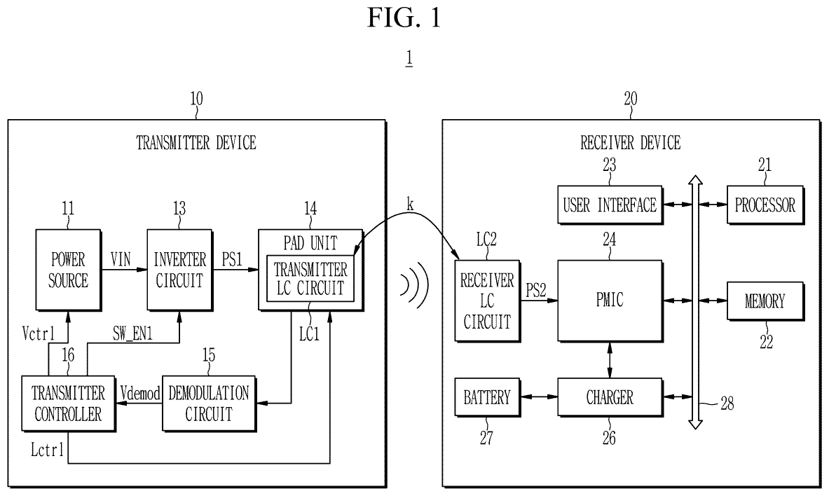

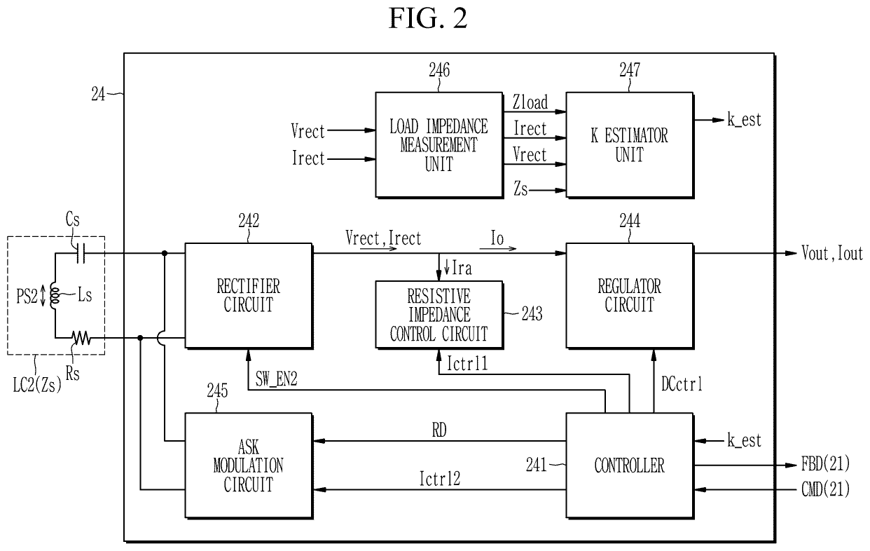

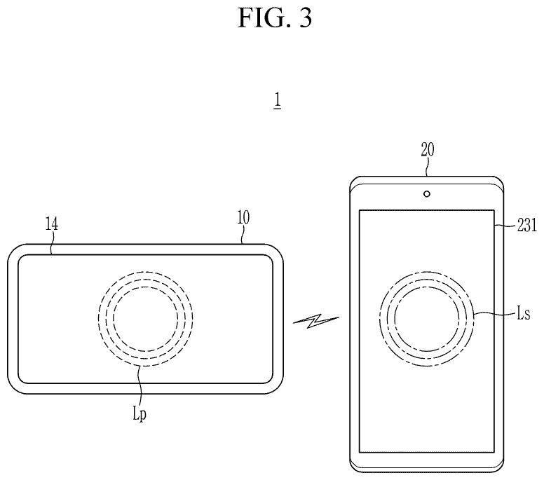

FIG. 1 is a block diagram illustrating a wireless charging system according to some example embodiments. FIG. 2 is a block diagram illustrating a PMIC according to some example embodiments. FIG. 3 is a diagram illustrating an example of an electronic device in a wireless charging system according to some example embodiments.

Referring to FIG. 1 and FIG. 2, the wireless charging system 1 may include a first electronic device 10 and a second electronic device 20. The first electronic device 10 and the second electronic device 20 may transmit and receive power wirelessly. According to some embodiments, the first electronic device 10 may transmit a power signal to the second electronic device 20 wirelessly. According to some embodiments, the first electronic device 10 may be provided with information related to the wireless power transmission/reception operation from the second electronic device 20 through the transmitted and received power signal.

The first electronic device 10 may be a power transmitter device and may transmit power through the induction of a coil. The first electronic device 10 may include a coil that may generate an induced magnetic field when current flows through an induction process. The process in which the first electronic device 10 generates an induced magnetic field may be expressed as the first electronic device 10 wirelessly transmitting a power signal. In addition, the second electronic device 20 may be a power receiver device and may receive power through the induction of a coil. The second electronic device 20 may include a coil that generates an induced electromotive force (e.g., current, voltage, and/or power) according to an induction method or a resonance method by a magnetic field generated in the vicinity. The process in which the second electronic device 20 generates an induced electromotive force by the surrounding magnetic field may be expressed as the second electronic device 20 wirelessly receiving a power signal. According to some embodiments, the first electronic device 10 and the second electronic device 20 may implement at least a part of the method defined in the Qi standard of the WPC (Wireless Power Consortium).

According to some embodiments, the first electronic device 10 may perform communication with the second electronic device 20. For example, the first electronic device 10 may perform communication with the second electronic device 20 according to an in-band method. The first electronic device 10 may perform modulation on data (or, a packet) to be sent to the second electronic device 20 according to, for example, an FSK (Frequency Shift Keying) modulation method, and the second electronic device 20 may provide data (or, a packet) to the first electronic device 10 by performing modulation according to an ASK (Amplitude Shift Keying) modulation method. The first electronic device 10 may check the data provided by the second electronic device 20 based on the amplitude of the current and/or voltage applied to the coil. According to some embodiments, the second electronic device 20 may control the on/off of at least one internal switch to send data to the first electronic device 10. For example, the second electronic device 20 may control operation of at least one internal switch to send data to the first electronic device 10. The operation of performing modulation based on the ASK modulation method and/or the FSK modulation method may be understood as an operation of sending data according to an in-band communication method, and the operation of performing demodulation based on the ASK demodulation method and/or the FSK demodulation method may be understood as an operation of receiving data according to an in-band communication method.

According to some embodiments, the first electronic device 10, according to a protocol defined in the Qi standard of the WPC, may transmit power to the second electronic device 20 through a ping phase, a configuration phase, a negotiation phase for the power transmitter device and the power receiver device to negotiate a wireless charging power level and other necessary information for charging, and a power transfer phase.

The first electronic device 10 may include a power source 11, an inverter circuit 13, a pad unit 14, a demodulation circuit 15, and a transmitter controller 16.

The transmitter controller 16 may control overall operations related to wireless charging of the first electronic device 10. The transmitter controller 16 may provide a voltage control signal Vctrl to the power source 11, provide a first switch enable signal SW_EN1 to the inverter circuit 13, and provide a location control signal Lctrl to the pad unit 14, thereby controlling the components in the first electronic device 10.

According to some embodiments, the transmitter controller 16 may be an MCU (Micro Controlling Unit), an FPGA (Field Programmable Gate Array), an ASIC (Application Specific Integrated Circuit), a microprocessor, or an AP (Application Processor), but is not limited to these examples.

The power source 11 may provide an input voltage VIN to the inverter circuit 13 based on the voltage control signal Vctrl from the transmitter controller 16. According to some embodiments, the input voltage VIN may be a DC voltage. The power source 11 may include at least one of an interface for connecting with an external TA travel adapter, a battery (not illustrated) of the first electronic device 10, a charger (not illustrated), and/or a PMIC (not illustrated). The power source 11 may provide DC power to the inverter circuit 13, but is not limited thereto, and according to an embodiment, the input voltage VIN generated by the power source 11 may be converted through a DC/DC converter (direct current-direct current conversion circuit) and provided to the inverter circuit 13. According to some embodiments, there is no limit to the magnitude of the power provided through the input voltage VIN.

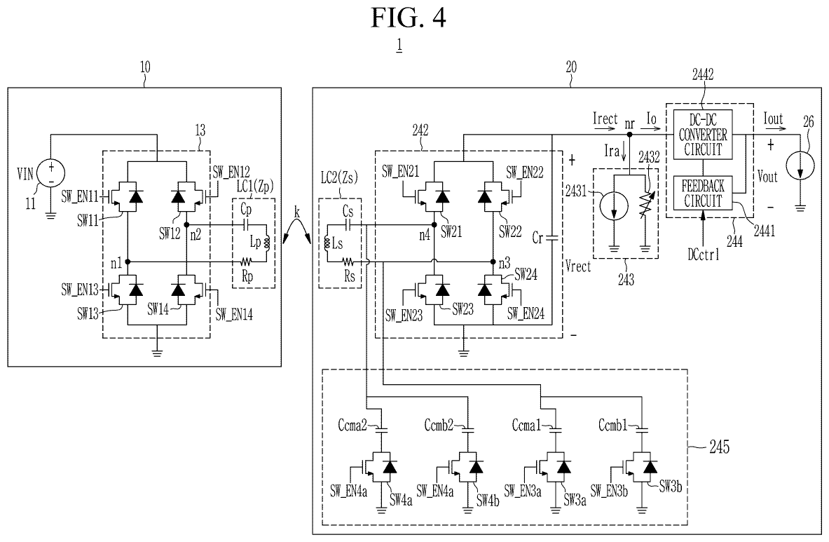

The inverter circuit 13 may use the input voltage VIN to provide a first power signal PS1 to the pad unit 14. According to some embodiments, the inverter circuit 13 includes a plurality of switches, and the plurality of switches may correspond to the primary first to quaternary first switches SW11 to SW14 of FIG. 4 and may implement a full-bridge circuit, but the number of switches or the type of circuit is not limited. The inverter circuit 13 may receive the first switch enable signal SW_EN1 from the transmitter controller 16 and generate the first power signal PS1 through a switching operation based on the first switch enable signal SW_EN1. According to an embodiment, the first power signal PS1 generated through the switching operation may be a rectangular wave signal in an AC form. According to some embodiments, based on the first switch enable signal SW_EN1, the presence or absence of the output of the first power signal PS1 may be controlled or the frequency of the first power signal PS1 may be adjusted. According to an embodiment, the frequency of the first power signal PS1 may be 100 kHz to 370 KHz.

The pad unit 14 may include a transmitter LC circuit LC1 including a coil and a capacitor. According to some embodiments, the coil and the capacitor in the transmitter LC circuit LC1 may be connected in series or in parallel with each other within the pad unit 14 depending on the power transmission method. The coil in the transmitter LC circuit LC1 may correspond to the transmitter coil Lp of FIG. 3 and FIG. 4, and the capacitor in the transmitter LC circuit LC1 may correspond to the transmitter capacitor Cp of FIG. 4. The pad unit 14 may receive the first power signal PS1 from the inverter circuit 13, and the first power signal PS1 may be provided to the coil in the transmitter LC circuit LC1.

As the first power signal PS1, which is an AC signal, is provided to the coil of the transmitter LC circuit LC1, the receiver coil Ls of the adjacently disposed receiver LC circuit LC2 and the coil of the transmitter LC circuit LC1 (e.g., transmitter coil Lp of FIG. 3) may be mutually induced. In the mutual induction process, the coil of the transmitter LC circuit LC1 may form a magnetic field based on the first power signal PS1, which is an AC signal. A part of the magnetic field (or, magnetic flux) formed by the coil of the transmitter LC circuit LC1 may pass through the cross-section of the receiver coil Ls. As the magnetic field passing through the cross-section of the receiver coil Ls changes with time, an induced electromotive force (for example, current, voltage, or power) may be generated in the receiver coil Ls. Through the above-described mutual induction, the transmitter LC circuit LC1 may transmit the first power signal PS1 and the receiver LC circuit LC2 may receive a second power signal PS2 corresponding to the first power signal PS1. According to an embodiment, the second power signal PS2 may be similar to a rectangular wave signal in an AC form, and the frequency of the signals in the first power signal PS1 and the frequency of the signals in the second power signal PS2 may be the same. According to some embodiments, the resonant frequency of the transmitter LC circuit LC1 and the receiver LC circuit LC2 may be substantially the same as the frequency of the first power signal PS1 and the second power signal PS2.

The degree of mutual induction is proportional to the coupling coefficient k between the two coils, and the power transmission efficiency may vary depending on the magnitude of the coupling coefficient k. The coupling coefficient k means the ratio of magnetic flux passing through both coils, and the coupling coefficient k may be changed according to at least one of an alignment state between the coils, a distance between the coils, the presence of foreign matter between the coils, and the size of the coils. In the present disclosure, the coupling coefficient k will be described on the premise that it is changed according to the alignment state between the coils among the above-mentioned causes of change.

According to some embodiments, the pad unit 14 may move the coil of the transmitter LC circuit LC1 based on the location control signal Lctrl. The transmitter controller 16 may repeatedly receive the estimated coupling coefficient value k_est calculated by the second electronic device 20, and may provide the location control signal Lctrl to the pad unit 14 based on the estimated coupling coefficient value k_est. In a direction in which the coupling coefficient k between the coil of the transmitter LC circuit LC1 and the receiver coil Ls increases, the coil of the transmitter LC circuit LC1 may move within the housing of the pad unit 14 based on the location control signal Lctrl. For example, the transmitter controller 16 may determine a position at which the coupling coefficient k between the coil of the transmitter LC circuit LC1 and the receiver coil Ls is at an increased value, and the transmitter controller 16 may transmit a location control signal Lctrl to the transmitter LC circuit LC1 to cause the coil of the transmitter LC circuit LC1 to move within the housing of the pad unit 14 based on the received location control signal Lctrl.

The demodulation circuit 15 may demodulate a signal applied to the coil of the transmitter LC circuit LC1 and output a demodulated signal Vdemod. The demodulation circuit 15 may output the demodulated signal Vdemod by down-converting a signal applied to the coil (for example, the voltage at both ends) by the frequency of the first power signal PS1 (for example, 100 kHz to 370 kHz). For example, the demodulation circuit 15 may include a mixer and/or a multiplier circuit for removing a carrier signal component for wireless power transmission (for example, the frequency of the first power signal PS1). Here, since a waveform in which the component due to the modulation of the second electronic device 20 and the first power signal PS1 are mixed may be applied to both ends of the coil of the transmitter LC circuit LC1, the frequency component of the first power signal PS1 has been named a carrier signal component, and one of ordinary skill in the art will understand that the second electronic device 20 does not actually generate a carrier and an electromagnetic wave by modulating the receiver data RD. According to some embodiments, the demodulation circuit 15 may include a low-pass filter and may filter and then output the demodulated signal Vdemod (low-pass filtering). Alternatively, the demodulation circuit 15 may filter both ends of the coil of the transmitter LC circuit LC1 and then down-convert by the frequency of the first power signal PS1 to generate the demodulated signal Vdemod. The voltage amplitude at both ends of the coil of the transmitter LC circuit LC1 may fluctuate according to the ASK modulation of the second electronic device 20.

According to some embodiments, the transmitter controller 16 may receive the receiver data RD provided by the second electronic device 20 based on the demodulated signal Vdemod generated by the demodulation circuit 15. The transmitter controller 16 may perform an ADC (analog-to-digital converting) operation on the demodulated signal Vdemod. The transmitter controller 16 may decode the digital value generated through the ADC operation, and receive the receiver data RD provided by the second electronic device 20 according to the decoding result. The decoding method may be, for example, according to the Qi standard, but is not limited thereto. Meanwhile, in the above-described embodiment, it is described that the demodulation circuit 15 performs frequency down-conversion for example, carrier removal and/or low-pass filtering, and the transmitter controller 16 performs an ADC operation and/or decoding, but this is merely exemplary. One of ordinary skill in the art will understand that the demodulation circuit 15 may be implemented to further perform at least one of an ADC operation and/or decoding, and the transmitter controller 16 may be implemented to further perform frequency down-conversion (for example, carrier removal and/or low-pass filtering).

The second electronic device 20 may include a processor 21, a memory 22, a user interface 23, a receiver LC circuit LC2, a PMIC 24, a charger 26, and a battery 27. The processor 21, the memory 22, the user interface 23, the PMIC 24, and the charger 26 may be electrically and/or operatively connected to each other by electronic components such as a communication bus 28.

The processor 21 may include hardware and/or circuitry for processing data based on one or more instructions. The hardware and/or circuitry for processing data may include, for example, an ALU (Arithmetic and Logic Unit), an FPU (Floating Point Unit), a CPU (Central Processing Unit), an FPGA, and/or an AP. The number of processors 21 may be one or more. For example, the processor 21 may have a multi-core processor structure such as a dual core, a quad core, a hexa core, or an octa core.

The processor 21 may control the overall operation of the second electronic device 20 and control the operation of components in the second electronic device 20 by providing commands to the components. Referring to FIG. 2 as an example, the processor 21 may provide a command CMD to the PMIC 24 to control the output voltage Vout and output current Iout output from the PMIC 24, and the controller 241 of the PMIC 24 may provide a regulator control signal DCctrl to the regulator circuit 244 in response to receiving the command CMD to control the operating current Io, output voltage Vout, and output current Iout of the regulator circuit 244.

The memory 22 may include a hardware configuration for storing data and/or instructions input to and/or output from the processor 21. The memory 22 may include, for example, volatile memory such as RAM (random-access memory) and/or non-volatile memory such as ROM (read-only memory). The volatile memory may include, for example, at least one of DRAM (dynamic RAM), SRAM (static RAM), Cache RAM, and PSRAM (pseudo SRAM). The non-volatile memory may include, for example, at least one of PROM (programmable ROM), EPROM (erasable PROM), EEPROM (electrically erasable PROM), flash memory, a hard disk, a compact disk, an SSD (solid state drive), and/or an eMMC (embedded multi-media card).

The user interface 23 may include one or more displays, speakers, haptic engine, vibrators, or any other output device. In addition, according to an embodiment, the user interface 23 may include a pen, a touch input device, a camera, a voice input device, a video input device, a keyboard, a mouse, or any other input device. According to some embodiments, the user interface 23 may display a status of the second electronic device 20 based on the control of the processor 21.

Referring to FIG. 3 as an example, the processor 21 may receive alignment feedback data FBD from the PMIC 24. The processor 21 may control the display 231 of the user interface 23 to display the alignment state with the coil of the first electronic device 10 based on the alignment feedback data FBD. The second electronic device 20 may make the user aware of the alignment state between the coils through the display operation of the display 231, and may induce the user to adjust the alignment state between the first electronic device 10 and the second electronic device 20.

Referring to FIG. 2 and FIG. 4, the receiver LC circuit LC2 may be connected to the PMIC 24 and may include a receiver coil Ls, a receiver capacitor Cs, and a receiving resistor Rs. The receiver LC circuit LC2 may have an equivalent impedance value of a receiving impedance Zs. According to some embodiments, the receiver coil Ls may correspond to the receiver coil Ls of FIG. 3. According to some embodiments, the receiving resistor Rs is a parasitic resistance for the receiver coil Ls, and the connection relationship between the receiver coil Ls and the receiver capacitor Cs in the receiver LC circuit LC2 may vary depending on the power transmission method.

The receiver LC circuit LC2 may perform narrow-band filtering centered on the resonant frequency. According to some embodiments, the resonant frequency of the receiver LC circuit LC2 may be substantially the same as the frequency of the second power signal PS2.

The receiver coil Ls may be mutually induced with the coil of the transmitter LC circuit LC1 based on the coupling coefficient k, and receive the second power signal PS2 through mutual induction and provide it to the PMIC 24. According to an embodiment, the second power signal PS2 may be an electrical signal in an AC form.

The PMIC 24 may rectify and convert the second power signal PS2 received from the receiver LC circuit LC2, and provide an output voltage Vout and an output current Iout to the charger 26. The charger 26 may charge the battery 27 based on the power provided from the PMIC 24. The charger 26 may control the voltage and/or current for charging the battery 27 according to the charging mode of the battery 27 (for example, constant current (CC) mode, constant voltage (CV) mode, or fast charging mode). According to some embodiments, the battery 27 may include a rechargeable secondary battery or a fuel cell.

The PMIC 24 may estimate the coupling coefficient k between the coil of the transmitter LC circuit LC1 and the coil of the receiver LC circuit LC2 to calculate an estimated coupling coefficient value k_est. The PMIC 24 may provide alignment feedback data FBD on the alignment state between the coil of the transmitter LC circuit LC1 and the coil of the receiver LC circuit LC2 to the processor 21 based on the estimated coupling coefficient value k_est, or may perform a modulation operation based on the estimated coupling coefficient value k_est to send the estimated coupling coefficient value k_est to the first electronic device 10. In the process of calculating the estimated coupling coefficient value k_est, the load impedance Zload at the output terminal of the receiver LC circuit LC2 may fluctuate. In present disclosure, the load impedance Zload may mean the equivalent impedance value of the part of the second electronic device 20 except for the receiver LC circuit LC2.

In addition, the PMIC 24, according to the control of the processor 21, may provide power obtained from the battery 27 to each of the hardware components (for example, the processor 21, the memory 22, the user interface 23, and/or the PMIC 24) within the second electronic device 20.

The PMIC 24 may include a controller 241, a rectifier circuit 242, a resistive impedance control circuit 243, a regulator circuit 244, a modulation circuit 245, a load impedance measurement unit 246, and a coupling coefficient estimator unit 247.

The controller 241 may control the overall operation of the PMIC 24. The controller 241 may receive a command CMD from the processor 21 and control the components within the PMIC 24 based on the command CMD. The controller 241 may provide a second switch enable signal SW_EN2 to the rectifier circuit 242, provide a first impedance control signal Ictrl1 to the resistive impedance control circuit 243, provide a regulator control signal DCctrl to the regulator circuit 244, and provide a second impedance control signal Ictrl2 to the modulation circuit 245 to control the components within the PMIC 24. In addition, the controller 241 may provide receiver data RD to the modulation circuit 245 to control the modulation circuit 245 to perform communication with the second electronic device 20 in an in-band method. According to some embodiments, the receiver data RD may include Power Receiver Data Packets defined in the Qi standard of the WPC.

The controller 241 may receive the estimated coupling coefficient value k_est from the coupling coefficient estimator unit 247 and compare the estimated coupling coefficient value k_est with a predetermined threshold value. The controller 241 may provide alignment feedback data FBD on the alignment state between the coil of the transmitter LC circuit LC1 and the coil of the receiver LC circuit LC2 to the processor 21 based on a comparison operation for the estimated coupling coefficient value k_est. In addition, the controller 241 may provide receiver data RD corresponding to the estimated coupling coefficient value k_est to the modulation circuit 245 so that a modulation operation for the estimated coupling coefficient value k_est is performed.

According to some embodiments, the controller 241 may be an MCU, an FPGA, an ASIC, a microprocessor, or an AP, but is not limited to these examples.

The rectifier circuit 242 may be electrically connected to the output terminal of the receiver LC circuit LC2. The rectifier circuit 242 may perform a rectification operation on the second power signal PS2 received through the receiver LC circuit LC2 to generate a rectification voltage Vrect, which is a DC voltage, and a rectification current Irect, which is a DC current. According to some embodiments, the rectifier circuit 242 may include a plurality of switches, and the plurality of switches may correspond to the primary second to quaternary second switches SW21 to SW24 of FIG. 4. The rectifier circuit 242 may receive the second switch enable signal SW_EN2 from the controller 241 and generate the rectification voltage Vrect and the rectification current Irect through a switching operation based on the second switch enable signal SW_EN2.

The regulator circuit 244 may generate an output voltage Vout and an output current Iout by performing a conversion operation (for example, buck converting, boost converting, low dropout, etc.) and/or a regulating operation on the rectification voltage Vrect output from the rectifier circuit 242. The regulator circuit 244 may receive an operating current Io in the conversion operation and the regulating operation, and the operating current Io may be at least a part of the rectification current Irect. According to some embodiments, the output voltage Vout and the output current Iout may be controlled by the regulator control signal DCctrl, and the magnitude of the operating current Io may also be adjusted by the regulator control signal DCctrl. According to some embodiments, due to the fluctuation of the operating current Io, the magnitude of the rectification current Irect may also fluctuate.

The resistive impedance control circuit 243 may be disposed between the rectifier circuit 242 and the regulator circuit 244, and may receive a resistive impedance adjustment current Ira based on the first impedance control signal Ictrl1. According to some embodiments, the resistive impedance adjustment current Ira may be at least a part of the rectification current Irect, and the magnitude of the rectification current Irect may also fluctuate according to the fluctuation of the resistive impedance adjustment current Ira. According to some embodiments, the resistive impedance control circuit 243 may include a variable resistor or a variable current source, but is not limited thereto.

According to some embodiments, as the rectification current Irect fluctuates due to the fluctuation of the operating current Io and the resistive impedance adjustment current Ira, the rectification voltage Vrect may fluctuate, and the load impedance Zload at the output terminal of the receiver LC circuit LC2 may also fluctuate.

The modulation circuit 245 may perform a modulation operation in response to the receiver data RD in an ASK modulation method. According to some embodiments, the receiver data RD may include the estimated coupling coefficient value k_est, a Control Error Packet requesting to adjust the input voltage VIN of the first electronic device 10 among the power receiver data packet, and the like.

According to some embodiments, the modulation circuit 245 may include a plurality of capacitors and a switch that controls the connection between the plurality of capacitors and the output terminal of the receiver LC circuit LC2. The modulation circuit 245 may select a capacitor to perform modulation among the plurality of capacitors based on the receiver data RD. The modulation capacitance of the modulation circuit 245 connected to the output terminal of the receiver LC circuit LC2 fluctuates according to the selected capacitor, and the difference in the amplitude of the voltage applied to the transmitter LC circuit LC1 may be adjusted.

Although not illustrated in the drawings, according to an embodiment, the receiver data RD may be encoded and then provided to the modulation circuit 245.

The modulation circuit 245 may control the connection between the output terminal of the receiver LC circuit LC2 and the capacitor based on the second impedance control signal Ictrl2 provided from the controller 241. In response to the connection between the output terminal of the receiver LC circuit LC2 and the capacitor, the reactance component of the load impedance Zload may fluctuate.

The load impedance measurement unit 246 may measure the load impedance Zload, based on the rectification voltage Vrect and the rectification current Irect generated from the rectifier circuit 242. According to some embodiments, the load impedance measurement unit 246 may include a voltage measurement circuit that monitors the rectification voltage Vrect and a current measurement circuit that monitors the rectification current Irect, and may measure the load impedance Zload based on the measured rectification voltage Vrect and the measured rectification current Irect, but is not limited thereto. According to some embodiments, the load impedance measurement unit 246 may receive the value of the rectification voltage Vrect and the value of the rectification current Irect, and may measure the load impedance Zload, based on the information about the rectification voltage Vrect and the rectification current Irect. According to some embodiments, the load impedance measurement unit 246 may be provided in the form of hardware as a dedicated circuit, but is not limited thereto, and when the load impedance measurement unit 246 is provided in the form of software, it may be implemented by the software execution of the controller 241.

The coupling coefficient estimator unit 247 may receive the rectification current Irect and the load impedance Zload corresponding to the rectification current Irect from the load impedance measurement unit 246. In addition, the coupling coefficient estimator unit 247 may receive the rectification voltage Vrect and a predetermined receiving impedance Zs. The coupling coefficient estimator unit 247 may calculate an estimated coupling coefficient value k_est based on a plurality of rectification currents Irect, a plurality of load impedances Zload, the receiving impedance Zs, and reactance information. The estimated coupling coefficient value k_est calculated by the coupling coefficient estimator unit 247 may be provided to the controller 241. The reactance information may be confirmed based on the fluctuation of the rectification voltage Vrect, and may be the polarity of the reactance component of the total input impedance viewed from the second electronic device 20.

In FIG. 2, it is illustrated that the coupling coefficient estimator unit 247 receives the rectification voltage Vrect and the rectification current Irect from the load impedance measurement unit 246, but it is not limited thereto, and according to an embodiment, the coupling coefficient estimator unit 247 may directly measure the rectification voltage Vrect and the rectification current Irect or receive the values as data.

According to some embodiments, the coupling coefficient estimator unit 247 may calculate one estimated coupling coefficient value k_est based on three rectification currents Irect, three load impedances Zload respectively corresponding to the three rectification currents Irect, and reactance information. According to another embodiment, the coupling coefficient estimator unit 247 may calculate one estimated coupling coefficient value k_est based on three rectification currents Irect and three load impedances Zload respectively corresponding to the three rectification currents Irect. According to another embodiment, the coupling coefficient estimator unit 247 may calculate one estimated coupling coefficient value k_est based on two rectification currents Irect and two load impedances Zload respectively corresponding to the two rectification currents Irect.

According to some embodiments, the coupling coefficient estimator unit 247 may be provided in the form of hardware as a dedicated circuit, but is not limited thereto, and when the coupling coefficient estimator unit 247 is provided in the form of software, it may be implemented by the software execution of the controller 241.

The second electronic device 20 may measure a plurality of load impedances Zload corresponding to a plurality of rectification currents Irect by changing the rectification current Irect through the resistive impedance control circuit 243, and may calculate an estimated coupling coefficient value k_est between the coil of the first electronic device 10 and the coil of the second electronic device 20 through the plurality of rectification currents Irect and the plurality of load impedances Zload.

The second electronic device 20 may perform a display operation of the user interface 23 based on the estimated coupling coefficient value k_est to make the user aware of the alignment state between the coils. The second electronic device 20 may induce the user to adjust the alignment state between the first electronic device 10 and the second electronic device 20 without including a separate member such as a magnet for coil alignment.

In addition, the second electronic device 20 may repeatedly send the estimated coupling coefficient value k_est to the first electronic device 10 to move the coil of the first electronic device 10 in a direction in which the coupling coefficient k between the coil of the first electronic device 10 and the coil of the second electronic device 20 increases. Through the movement of the coil in the first electronic device 10, the second electronic device 20, which is a power receiver device, may cost-effectively induce optimal alignment between the coils without including a separate member such as a magnet for alignment.

FIG. 3 is a drawing illustrating an example of an electronic device in a wireless charging system according to some example embodiments.

Referring to FIG. 3, the first electronic device 10 may be a wireless charging device. A pad unit 14 is disposed adjacent to the outer surface of the first electronic device 10, and a transmitter coil Lp may be disposed within the housing of the pad unit 14. The transmitter coil Lp may correspond to the coil of the transmitter LC circuit LC1 of FIG. 1. The transmitter coil Lp may have the form of closed loops, and although the transmitter coil Lp is illustrated in the drawing as including a conductive wire wound in a spiral and/or concentric form, this is only an exemplary form and is not limited thereto. The transmitter coil Lp may be configured to transmit or receive a power signal.

The second electronic device 20 may be referred to as a terminal (or a user terminal). Although the terminal, which is the second electronic device 20, is illustrated as a smartphone in FIG. 3, it is not limited thereto. The terminal may include, for example, a smartpad and/or a tablet PC, and may include smart accessories such as a smartwatch and/or an HMD head-mounted device. The terminal may include a device that is implantable in a user's body for example, a pacemaker, an insulin pump, and/or cochlear implants. The embodiment is not limited to this, and the terminal may include, for example, a personal computer PC such as a laptop and a desktop.

Receiver coil Ls may be disposed adjacent to one surface (for example, rear surface) of the second electronic device 20, or may be disposed on another surface parallel or opposite to the one surface (for example, rear surface) inside the second electronic device 20. The receiver coil Ls may correspond to the receiver coil Ls of the receiver LC circuit LC2 of FIG. 1 and FIG. 2. The receiver coil Ls may be disposed on another surface opposite to one surface (for example, front surface of the second electronic device 20) on which a display 231 is disposed, that is, on an inner surface of a housing forming the exterior. According to some embodiments, the receiver coil Ls may be included in an FPCB (Flexible Printed Circuit Board) and/or a PCB (Printed Circuit Board) adjacent to the rear surface of the second electronic device 20 within the second electronic device 20. According to some embodiments, the receiver coil Ls may have the form of a closed loop, and although the receiver coil Ls is illustrated in the drawing as including a conductive wire wound in a spiral and/or concentric form, this is only an exemplary form and is not limited thereto. The receiver coil Ls may be configured to transmit or receive a power signal.

The second electronic device 20 may be mounted on the outer surface of the first electronic device 10 where the pad unit 14 is adjacently disposed. Through the arrangement of the pad unit 14 in the first electronic device 10, the first electronic device 10 may reduce the distance between the transmitter coil Lp and the receiver coil Ls and increase the coupling coefficient k with the receiver coil Ls. Through the arrangement of the pad unit 14 as described above, the transmitter coil Lp and the receiver coil Ls may be mutually induced based on a relatively large coupling coefficient k.

The second electronic device 20 may perform a display operation of the display 231 based on the estimated coupling coefficient value k_est to make a user aware of the alignment state between the transmitter coil Lp and the receiver coil Ls. The second electronic device 20 may induce the user to adjust the alignment state between the first electronic device 10 and the second electronic device 20 without including a separate member such as a magnet for coil alignment.

In addition, the transmitter coil Lp may move in response to the estimated coupling coefficient value k_est received from the second electronic device 20. The second electronic device 20 may repeatedly send the estimated coupling coefficient value k_est to the first electronic device 10 to move the coil of the transmitter coil Lp in a direction in which the coupling coefficient k between the transmitter coil Lp and the receiver coil Ls increases. Through the movement of the transmitter coil Lp, the second electronic device 20, which is a power receiver device, may cost-effectively induce optimal alignment between the coils without including a separate member such as a magnet for alignment.

Although the first electronic device 10 is illustrated as a wireless charging device in the drawing, it is not limited thereto, and according to an embodiment, the first electronic device 10 may be implemented in the form of a user terminal.

FIG. 4 is a circuit diagram illustrating a wireless charging system according to some example embodiments. Specifically, FIG. 4 illustrates an exemplary circuit of the wireless charging system 1. The first electronic device 10, power source 11, inverter circuit 13, transmitter LC circuit LC1, second electronic device 20, receiver LC circuit LC2, rectifier circuit 242, resistive impedance control circuit 243, regulator circuit 244, and modulation circuit 245 of FIG. 4 may respectively correspond to the first electronic device 10, power source 11, inverter circuit 13, transmitter LC circuit LC1, second electronic device 20, receiver LC circuit LC2, rectifier circuit 242, resistive impedance control circuit 243, regulator circuit 244, and modulation circuit 245 of FIG. 1 and FIG. 2.

Referring to FIG. 4, the first electronic device 10 may include a power source 11, an inverter circuit 13, and a transmitter LC circuit LC1, and the second electronic device 20 may include a receiver LC circuit LC2, a rectifier circuit 242, a resistive impedance control circuit 243, a regulator circuit 244, a modulation circuit 245, and a charger 26.

The inverter circuit 13 may output an AC signal using the input voltage VIN. The inverter circuit 13 may include a plurality of first switches SW11 to SW14. In FIG. 4, the plurality of first switches SW11 to SW14 are arranged in a full-bridge circuit form, but it is not limited thereto, and the number of switches or the type of circuit may vary according to an embodiment.

The primary first switch SW11 may be controlled by a primary first switch enable signal SW_EN11 and may include one end connected to the power source 11 and the other end connected to a first node n1.

The secondary first switch SW12 may be controlled by a secondary first switch enable signal SW_EN12 and may include one end connected to the power source 11 and the other end connected to a second node n2. The tertiary first switch SW13 may be controlled by a tertiary first switch enable signal SW_EN13 and may include one end connected to the first node n1 and the other end connected to ground. The quaternary first switch SW14 may be controlled by a quaternary first switch enable signal SW_EN14 and may include one end connected to the second node n2 and the other end connected to ground. The first node n1 between the primary first switch SW11 and the tertiary first switch SW13 is connected to one end of the transmitter LC circuit LC1, and the second node n2 between the secondary first switch SW12 and the quaternary first switch SW14 may be connected to the other end of the transmitter LC circuit LC1. The primary first to quaternary first switch enable signals SW_EN11 to SW_EN14 may correspond to the first switch enable signal SW_EN1 of FIG. 1 and may be received from the transmitter controller 16 of FIG. 1. According to some embodiments, each of the plurality of first switches SW11 to SW14 includes a transistor and a diode, and the transistor and the diode may be connected in parallel at both ends.

The plurality of first switches SW11 to SW14 may be turned on or turned off based on the primary first to quaternary first switch enable signals SW_EN11 to SW_EN14, and an AC signal may be generated through control of the turn-on operation for the plurality of first switches SW11 to SW14. In a first period, the primary first switch SW11 and the quaternary first switch SW14 may be turned on and the secondary first switch SW12 and the tertiary first switch SW13 may be turned off, and in a second period, the secondary first switch SW12 and the tertiary first switch SW13 may be turned on, and the primary first switch SW11 and the quaternary first switch SW14 may be turned off. During the generation of AC power, the switching operation in the first period and the second period may be repeated. In addition, through the control of the switching operation for the plurality of first switches SW11 to SW14, the presence or absence of the output of the AC signal may be controlled or the frequency of the AC signal may be adjusted.

The transmitter LC circuit LC1 may be connected to the inverter circuit 13 through the first and second nodes n1, n2, and may receive the AC signal generated in the inverter circuit 13 as a transmitting power signal.

The transmitter LC circuit LC1 may include a transmitter coil Lp, a transmitter capacitor Cp, and a transmitter resistor Rp, and may have an equivalent impedance value of a transmitting impedance Zp. According to some embodiments, the transmitter coil Lp may correspond to the coil in the transmitter LC circuit LC1 of FIG. 1. According to some embodiments, the transmitter resistor Rp may be a parasitic resistance for the transmitter coil Lp, and the connection relationship between the transmitter coil Lp and the transmitter capacitor Cp in the transmitter LC circuit LC1 may vary depending on the power transmission method.

The transmitter coil Lp may be mutually induced with the receiver coil Ls of the receiver LC circuit LC2 based on the coupling coefficient k, and transmit a power signal to the receiver LC circuit LC2 through mutual induction.

The receiver coil Ls may be mutually induced with the transmitter coil Lp based on the coupling coefficient k, and through mutual induction, the receiver LC circuit LC2 may receive a power signal, which is an AC signal, and provide it to the rectifier circuit 242. The receiver LC circuit LC2 may be connected to the rectifier circuit 242 through third and fourth nodes n3, n4. One end of the receiver LC circuit LC2 may be connected to the fourth node n4, and the other end of the receiver LC circuit LC2 may be connected to the third node n3.

The rectifier circuit 242 may receive the AC signal received through the receiver LC circuit LC2 and convert the AC signal into a DC signal. The rectifier circuit 242 may apply a rectification voltage Vrect to a rectification node nr and provide a rectification current Irect to the rectification node nr based on the AC signal.

The rectifier circuit 242 may include a plurality of second switches SW21 to SW24 and a rectifier capacitor Cr. In FIG. 4, the plurality of second switches SW21 to SW24 may be arranged in a full-bridge circuit form, but it is not limited thereto, and the number of switches or the type of circuit may vary according to an embodiment.

The primary second switch SW21 may be controlled by a primary second switch enable signal SW_EN21 and may include one end connected to the rectification node nr and the other end connected to the fourth node n4. The secondary second switch SW22 may be controlled by a secondary second switch enable signal SW_EN22 and include one end connected to the rectification node nr and the other end connected to the third node n3. The tertiary second switch SW23 may be controlled by a tertiary second switch enable signal SW_EN23 and may include one end connected to the fourth node n4 and the other end connected to ground. The quaternary second switch SW24 may controlled by a quaternary second switch enable signal SW_EN24 and may include one end connected to the third node n3 and the other end connected to ground. The fourth node n4 between the primary second switch SW21 and the tertiary second switch SW23 may be connected to one end of the receiver LC circuit LC2, and the third node n3 between the secondary second switch SW22 and the quaternary second switch SW24 may be connected to the other end of the receiver LC circuit LC2. The primary second to quaternary second switch enable signals SW_EN21 to SW_EN24 may correspond to the second switch enable signal SW_EN2 of FIG. 1 and may be received from the controller 241 of FIG. 2. According to some embodiments, each of the plurality of second switches SW21 to SW24 includes a transistor and a diode, and the transistor and the diode may be connected in parallel at both ends.

The plurality of second switches SW21 to SW24 may be turned on or turned off based on the primary second to quaternary second switch enable signals SW_EN21 to SW_EN24, and a rectification voltage Vrect and a rectification current Irect, which are DC signals, may be generated through control of the turn-on operation for the plurality of second switches SW21 to SW24.

A rectifier capacitor Cr may be disposed between the rectification node nr and a ground terminal, and maintain the rectification voltage Vrect at the rectification node nr. According to some embodiments, the rectifier capacitor Cr may smooth a high-frequency component included in the rectification voltage Vrect and may be referred to as a smoothing capacitor.

The resistive impedance control circuit 243 may receive a resistive impedance adjustment current Ira from the rectification node nr. The resistive impedance control circuit 243 may include a variable current source 2431 disposed between the rectification node nr and a ground terminal and a variable resistor 2432 disposed between the rectification node nr and the ground terminal.

The resistive impedance control circuit 243 may change the resistive impedance adjustment current Ira by controlling the current flowing in the variable current source 2431 or adjusting the resistance value of the variable resistor 2432. The current magnitude of the variable current source 2431 and the resistance magnitude of the variable resistor 2432 may be adjusted based on the first impedance control signal Ictrl1 of FIG. 2. According to some embodiments, as the resistive impedance adjustment current Ira fluctuates, the rectification current Irect may fluctuate, and as the rectification current Irect fluctuates, the load impedance may fluctuate.

The regulator circuit 244 may perform a conversion operation on the rectification voltage Vrect to generate an output voltage Vout and an output current Iout, and stably output the output voltage Vout and the output current Iout. The generated output voltage Vout and output current Iout may be provided to the charger 26. The charger 26 may correspond to the charger 26 of FIG. 1.

The regulator circuit 244 may include a DC-DC converter circuit 2442 and a feedback circuit 2441. The DC-DC converter circuit 2442 may perform a conversion operation on the rectification voltage Vrect to generate the output voltage Vout, and may filter noise of the output voltage Vout. The feedback circuit 2441 may sense a difference between the output voltage Vout and a reference voltage and may perform an amplification operation on the difference between the output voltage Vout and the reference voltage.

The regulator circuit 244 may receive an operating current Io from the rectification node nr in the conversion and amplification operations, and the operating current Io may be at least a part of the rectification current Irect. The magnitude of the output voltage Vout, the magnitude of the output current Iout, and the magnitude of the operating current Io may be adjusted by the regulator control signal DCctrl. According to some embodiments, as the operating current Io fluctuates, the rectification current Irect may fluctuate, and as the rectification current Irect fluctuates, the load impedance may fluctuate.

The modulation circuit 245 may include a plurality of modulation capacitors Ccma1, Ccma2, Ccmb1, Ccmb2 and a plurality of selection switches SW3a, SW4a, SW3b, SW4b.

The primary first modulation capacitor Ccma1 may include one electrode connected to the third node n3 and the other electrode connected to one end of the primary third selection switch SW3a.

The primary second modulation capacitor Ccmb1 may include one electrode connected to the third node n3 and the other electrode connected to one end of the secondary third selection switch SW3b. The secondary first modulation capacitor Ccma2 may include one electrode connected to the fourth node n4 and the other electrode connected to one end of the primary fourth selection switch SW4a. The secondary second modulation capacitor Ccmb2 may include one electrode connected to the fourth node n4 and the other electrode connected to one end of the secondary fourth selection switch SW4b. According to some embodiments, the capacitance of the primary first modulation capacitor Ccma1 and the capacitance of the secondary first modulation capacitor Ccma2 may be the same, and the capacitance of the primary second modulation capacitor Ccmb1 and the capacitance of the secondary second modulation capacitor Ccmb2 may be the same.

The primary third selection switch SW3a is controlled by a primary third selection signal SW_EN3a and may include one end connected to the other electrode of the primary first modulation capacitor Ccma1 and the other end connected to ground. The secondary third selection switch SW3b is controlled by a secondary third selection signal SW_EN3b and may include one end connected to the other electrode of the primary second modulation capacitor Ccmb1 and the other end connected to ground. The primary fourth selection switch SW4a is controlled by a primary fourth selection signal SW_EN4a and may include one end connected to the other electrode of the secondary first modulation capacitor Ccma2 and the other end connected to ground. The secondary fourth selection switch SW4b is controlled by a secondary fourth selection signal SW_EN4b and may include one end connected to the other electrode of the secondary second modulation capacitor Ccmb2 and the other end connected to ground.

The plurality of selection signals SW_EN3a, SW_EN4a, SW_EN3b, SW_EN4b may correspond to the receiver data RD and the second impedance control signal Ictrl2 generated by the controller 241 of FIG. 2. The plurality of selection switches SW3a, SW4a, SW3b, SW4b may be turned on based on the plurality of selection signals SW_EN3a, SW_EN4a, SW_EN3b, SW_EN4b.

Through control of the turn-on operation of the plurality of selection switches SW3a, SW4a, SW3b, SW4b, the electrical connection between the third and fourth nodes n3, n4 and the plurality of modulation capacitors Ccma1, Ccma2, Ccmb1, Ccmb2 may be controlled. The third and fourth nodes n3, n4 may be nodes to which the output terminal of the receiver LC circuit LC2 is connected, and the degree of modulation may be adjusted as the electrical connection to the plurality of modulation capacitors Ccma1, Ccma2, Ccmb1, Ccmb2 is controlled.

According to some embodiments, the controller 241 of FIG. 2 may control the electrical connection between the third and fourth nodes n3, n4 and the plurality of modulation capacitors Ccma1, Ccma2, Ccmb1, Ccmb2 based on the receiver data RD. According to some embodiments, the controller 241 of FIG. 2 may control the electrical connection between the third and fourth nodes n3, n4 and the plurality of modulation capacitors Ccma1, Ccma2, Ccmb1, Ccmb2 based on the second impedance control signal Ictrl2.

As the connection to the third and fourth nodes n3, n4 and the plurality of modulation capacitors Ccma1, Ccma2, Ccmb1, Ccmb2 is controlled, the reactance of the load impedance fluctuates, and the voltage amplitude across the transmitter coil Lp, the voltage amplitude across the receiver coil Ls, and the magnitude of the rectification voltage Vrect may fluctuate.

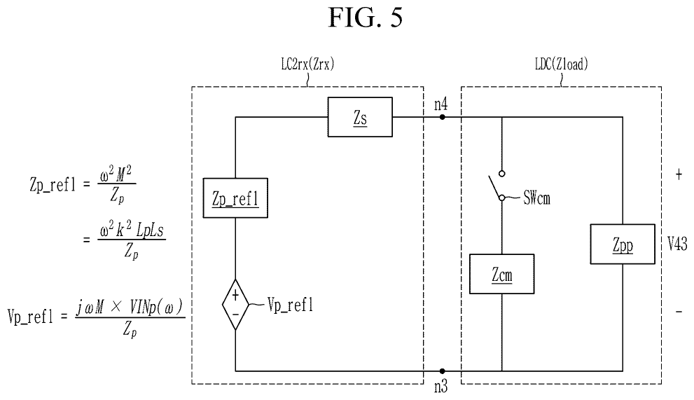

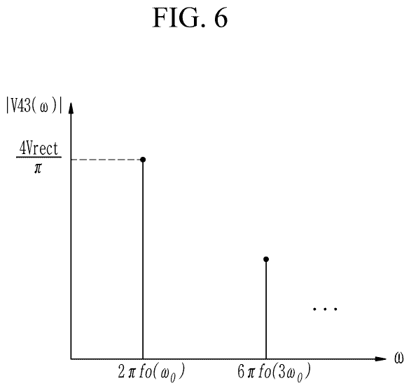

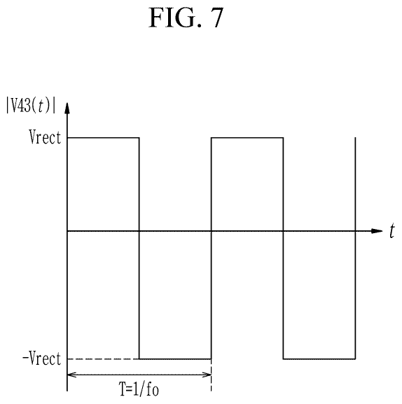

FIG. 5 is a drawing modeling a wireless charging system in the frequency domain according to some example embodiments. FIG. 6 and FIG. 7 are drawings for explaining a received power signal according to some example embodiments.

Specifically, FIG. 5 is an equivalent circuit for the first electronic device 10 and the second electronic device 20 of FIG. 1 and FIG. 4 as seen from the third and fourth nodes n3, n4 connected to the output terminal of the receiver LC circuit LC2. Specifically, FIG. 6 and FIG. 7 are graphs respectively showing an AC voltage signal V43, which is a power signal received at the third and fourth nodes n3, n4, in the frequency domain and the time domain.

Referring to FIG. 1, FIG. 4, and FIG. 5, when viewing the second electronic device 20 except for the receiver LC circuit LC2 from the third and fourth nodes n3, n4, the second electronic device 20 except for the receiver LC circuit LC2 may be modeled as a load circuit LDC in the frequency domain.

The load circuit LDC may include a modulation impedance Zcm, a modulation selection switch SWcm, and a power path impedance Zpp. Between the third and fourth nodes n3, n4, the modulation impedance Zcm and the modulation selection switch SWcm may be connected in parallel with the power path impedance Zpp.

The load circuit LDC may have an equivalent impedance value of a load impedance Zload. The load impedance Zload may be calculated based on the modulation impedance Zcm and the power path impedance Zpp according to the operation of the modulation selection switch SWcm. In response to the modulation selection switch SWcm being open, the load impedance Zload may be equal to the power path impedance Zpp. In response to the modulation selection switch SWcm being shorted, the load impedance Zload may be calculated in a parallel synthesis manner for the modulation impedance Zcm and the power path impedance Zpp.

The modulation impedance Zcm and the modulation selection switch SWcm may correspond to the modulation circuit 245 of FIG. 2 and FIG. 4, and the modulation selection switch SWcm may correspond to the plurality of selection switches SW3a, SW4a, SW3b, SW4b of FIG. 4. The modulation impedance Zcm may correspond to the plurality of modulation capacitors Ccma1, Ccma2, Ccmb1, Ccmb2 of FIG. 4, and may mean an equivalent impedance value for the plurality of modulation capacitors Ccma1, Ccma2, Ccmb1, Ccmb2 selected by the plurality of selection switches SW3a, SW4a, SW3b, SW4b. The modulation impedance Zcm may be determined by the modulation capacitance for the modulation circuit 245.

According to some embodiments, in response to the connection between the third and fourth nodes n3, n4 and the plurality of modulation capacitors Ccma1, Ccma2, Ccmb1, Ccmb2, the reactance component of the load impedance Zload may fluctuate.

The power path impedance Zpp may mean an equivalent impedance value of a part of the second electronic device 20 except for the receiver LC circuit LC2 and the modulation circuit 245. Referring to FIG. 4 as an example, the power path impedance Zpp may correspond to a total equivalent impedance value for the rectifier circuit 242, the resistive impedance control circuit 243, the regulator circuit 244, the charger 26, and the like.

According to some embodiments, an AC voltage signal V43 may be applied between the third and fourth nodes n3, n4.

Through the switching operation of the inverter circuit 13 and the narrow-band filtering operation for the resonant frequency of the receiver LC circuit LC2, the AC voltage signal V43 may include an impulse voltage signal at the resonant frequency (for example, a spike signal) and an impulse voltage signal at a harmonic frequency of the resonant frequency. For example, the AC voltage signal V43 may include an impulse voltage at the resonant frequency (e.g., a voltage spike) as well as impulses at harmonics of the resonant frequency.

Referring additionally to FIG. 6 and FIG. 7, the AC voltage signal V43 may include an impulse voltage signal at the resonant frequency fo and an impulse voltage signal at a 2n+1 times harmonic of the resonant frequency fo. The n is a natural number. The magnitude of the impulse voltage signal at the resonant frequency fo may be 4/TT times the rectification voltage Vrect and determined by the load impedance Zload. In addition, the magnitude of the impulse voltage signal at the 2n+1 times harmonic of the resonant frequency fo may be determined by the load impedance Zload.

Therefore, the AC voltage signal V43 may be a square wave having a resonance period T and an amplitude of the rectification voltage Vrect in the time domain. The resonance period T may be the reciprocal of the resonant frequency fo. Although the AC voltage signal V43 is illustrated as a smoothed square wave in the time domain in FIG. 7, it is not limited thereto, and the AC voltage signal V43 may rise or fall with a non-zero slope value in some sections.

When viewing the receiver LC circuit LC2 and the first electronic device 10 from the third and fourth nodes n3, n4, the receiver LC circuit LC2 and the first electronic device 10 may be modeled as a total input LC circuit LC2rx in the frequency domain.

The total input LC circuit LC2rx may include a reflected power source Vp_refl, a reflected impedance Zp_refl, and a receiving impedance Zs. Between the third node n3 and the fourth node n4, the reflected power source Vp_refl, the reflected impedance Zp_refl, and the receiving impedance Zs may be connected in series.

The total input LC circuit LC2rx may have an equivalent impedance value of a total input impedance Zrx. The total input impedance Zrx may be calculated in a series synthesis manner for the reflected impedance Zp_refl and the receiving impedance Zs.

The reflected power source Vp_refl may represent the reflected voltage induced when the magnetic field created by the AC signal flowing in the transmitter coil Lp reaches the receiver coil Ls in the form of a “voltage source,” and be expressed as in Equation 1 below.

$$Vp\_refl = \frac{j ω M \times VINp ( ω )}{Zp} \qquad ( Equation 1 )$$

In Equation 1, Vp_refl is the reflected voltage provided by the reflected power source as viewed from the power receiver device, ω is the angular frequency of the AC signal generated in the power transmitter device, M is the mutual inductance between the transmitter coil and the receiver coil, VINp(ω) is the AC signal generated in the power transmitter device, and Zp is the transmitting impedance for the transmitter LC circuit in the power transmitter device.

The reflected impedance Zp_refl may represent the electrical effect of the transmitter LC circuit LC1 appearing on the receiver LC circuit LC2 in the process of mutual induction between the transmitter LC circuit LC1 and the receiver LC circuit LC2 in the form of an “impedance,” and be expressed as in Equation 2 below.

$$Zp\_refl = \frac{{ω}^{2} {M}^{2}}{Zp} = \frac{{ω}^{2} {k}^{2} LpLs}{Zp} \qquad ( Equation 2 )$$

In Equation 2, Zp_refl is the reflected impedance as viewed from the power receiver device, ω is the angular frequency of the reflected voltage, M is the mutual inductance between the transmitter coil and the receiver coil, Zp is the transmitting impedance for the transmitter LC circuit in the power transmitter device, k is the coupling coefficient between the transmitter coil in the power transmitter device and the receiver coil in the power receiver device, Lp is the inductance for the transmitter coil in the power transmitter device, and Ls is the inductance for the receiver coil in the power receiver device.

The coupling coefficient k between the transmitter coil Lp and the receiver coil Ls may be expressed as in Equation 3 below, based on Equation 2.

$$k = \sqrt{\vert \frac{Zp\_refl \times Zp}{{ω}^{2} LpLs} \vert} = \sqrt{\vert \frac{Zp\_refl}{ω Ls} \vert} \times \sqrt{\vert \frac{Zp}{ω Lp} \vert} \qquad ( Equation 3 )$$

Assuming an environment where the magnitude of the transmitting impedance Zp and the magnitude of the impedance for the transmitter coil Lp are similar in Equation 3, the coupling coefficient k may be approximated as in Equation 4 below.

$$k = \sqrt{\vert \frac{Zp\_refl}{ω Ls} \vert} \qquad ( Equation 4 )$$

The coupling coefficient k may be calculated through the reflected impedance Zp_refl as viewed from the second electronic device 20, which is the power receiver device, based on Equation 4. According to some embodiments, the coupling coefficient k may be determined through the resistance and reactance of the reflected impedance Zp_refl.

The second electronic device 20 may derive a plurality of equations for the unknown reflected impedance Zp_refl and reflected power source Vp_refl while changing the load impedance Zload, and may calculate the estimated coupling coefficient value k_est by finding the solution to the plurality of equations.

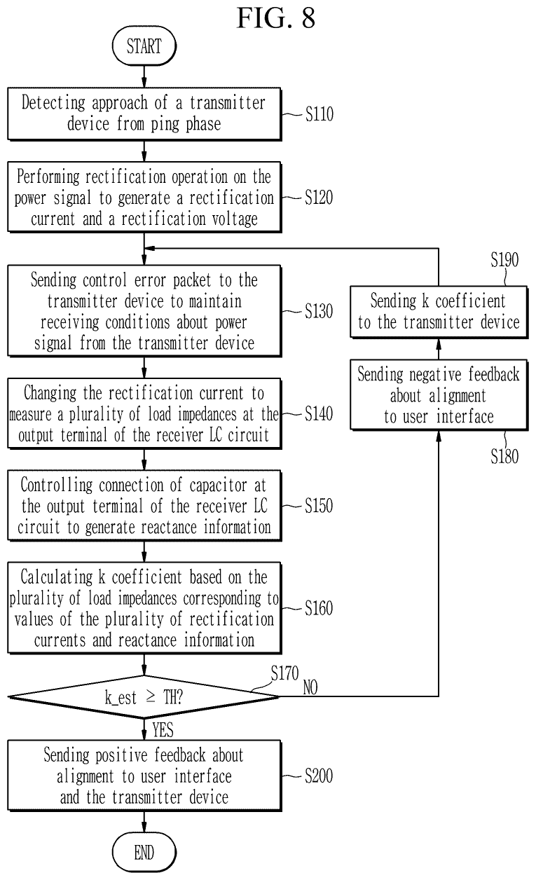

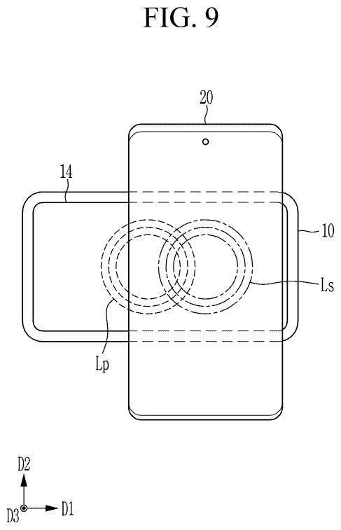

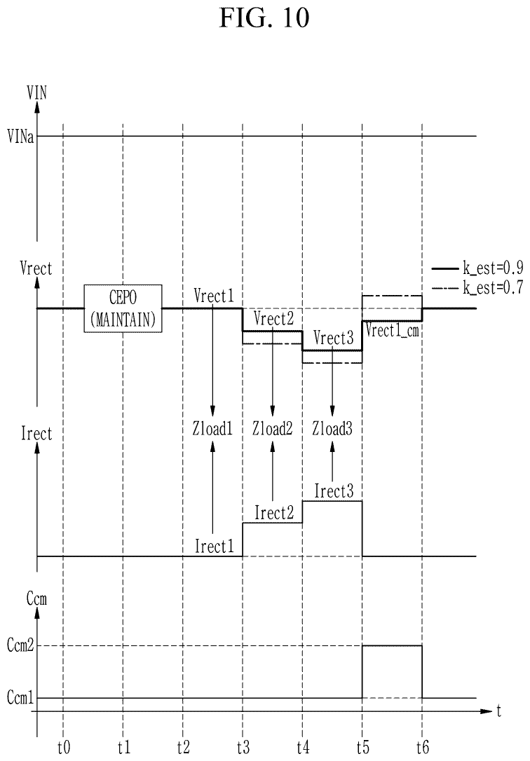

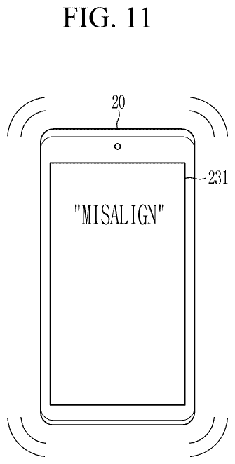

FIG. 8 is a flowchart illustrating a method of operating an electronic device according to some example embodiments. FIG. 9 to FIG. 11 are drawings for explaining a method of operating an electronic device according to some example embodiments.

Referring to FIG. 1, FIG. 2, FIG. 5, FIG. 6, and FIG. 8, the second electronic device 20 detects the first electronic device 10, which is a power transmitter device, from the ping phase (S110).

The second electronic device 20, which is a power receiver device, may be disposed adjacent to the first electronic device 10. Referring to FIG. 9 as an example, the second electronic device 20 may be mounted on the outer surface of the first electronic device 10, and the receiver coil Ls of the second electronic device 20 and the transmitter coil Lp of the first electronic device 10 may be misaligned with each other in a first direction D1.

The first electronic device 10 may check whether the adjacently disposed second electronic device 20 is included within the operating volume in the ping phase. For example, during the ping phase, the first electronic device 10 may determine whether the second electronic device 20, which is positioned adjacent to the first device, is located within a defined operating area. According to some embodiments, the first electronic device 10 may use an analog ping, apply NFC tag protection, or check for the presence of FOD (foreign object detection).

If the first electronic device 10 confirms that the second electronic device 20 is included within the operating volume, the first electronic device 10 may provide a digital ping in the ping phase to request a signal strength data packet.

The second electronic device 20 may provide a signal strength data packet to the first electronic device 10 in response to the digital ping of the first electronic device 10 in the ping phase and may detect the first electronic device 10.

The ping phase in step S110 may correspond to the ping phase defined in the Qi standard of the WPC.

The second electronic device 20 performs a rectification operation on the second power signal PS2 to generate a rectification voltage Vrect and a rectification current Irect (S120).

After the ping phase in step S110, through a configuration phase and a negotiation phase, the second electronic device 20 may receive a second power signal PS2 based on the first power signal PS1 generated by the first electronic device 10. The second power signal PS2 may correspond to the first power signal PS1, and the magnitude of the second power signal PS2 may be determined by the magnitude of the first power signal PS1. Therefore, the magnitude of the second power signal PS2 may be based on the input voltage VIN.

Referring to FIG. 4 as an example, the rectifier circuit 242 may perform a rectification operation on the second power signal PS2 to generate a rectification current Irect flowing to the rectification node nr and generate a rectification voltage Vrect applied to the rectification node nr.

Referring additionally to FIG. 10, at time to, the first electronic device 10 may generate a first power signal PS1 based on an a-th input voltage VINa, and the second electronic device 20 may receive a second power signal PS2 corresponding to the a-th input voltage VINa.

The rectifier circuit 242 may perform a rectification operation on the second power signal PS2 corresponding to the a-th input voltage VINa, and may generate a first rectification current Irect1 flowing to the rectification node (e.g., rectification node nr in FIG. 4) and may generate a first rectification voltage Vrect1 applied to the rectification node (e.g., rectification node nr in FIG. 4).

The second electronic device 20 sends a control error packet to the first electronic device 10 to maintain a reception condition for the power signal received from the first electronic device 10 (S130).

In correspondence with the reception of the second power signal PS2, the controller 241 of the second electronic device 20 may generate a zeroth (e.g., an initial) control error packet CEP0 requesting the maintenance of the reception condition for the second power signal PS2. For example, the second electronic device 20 may request the first electronic device 10 to maintain the input voltage VIN at the existing voltage, the a-th input voltage VINa, through the zeroth control error packet CEP0 in the process of calculating the estimated coupling coefficient value k_est. The zeroth control error packet CEP0 is one of the control error packets defined in the Qi standard of the WPC and may be the receiver data RD generated by the controller 241.

The transmitter controller 16 in the first electronic device 10 may provide a voltage control signal Vctrl to the power source 11 based on the zeroth control error packet CEP0 and may maintain the input voltage VIN at the existing voltage, the a-th input voltage VINa.

At time t1, the modulation circuit 245 may perform a modulation operation based on the zeroth control error packet CEP0, and the second electronic device 20 may send the zeroth control error packet CEP0 to the first electronic device 10 through the modulation operation. In the modulation operation, the rectification voltage Vrect generated from the rectifier circuit 242 may fluctuate.

At time t2, after the sending of the zeroth control error packet CEP0, the rectifier circuit 242 may perform a rectification operation on the second power signal PS2 and may generate a first rectification current Irect1 and a first rectification voltage Vrect1. In addition, the load impedance measurement unit 246 may measure a first load impedance Zload1 corresponding to the first rectification current Irect1 based on the first rectification current Irect1 and the first rectification voltage Vrect1.

The second electronic device 20 changes the rectification current Irect to measure a plurality of load impedances Zload at the output terminal of the receiver LC circuit LC2 (S140).

The rectification current Irect may fluctuate, based on the fluctuation of the resistive impedance adjustment current Ira and the operating current Io. According to some embodiments, the resistive impedance control circuit 243 may change the rectification current Irect by changing the resistive impedance adjustment current Ira based on the first impedance control signal Ictrl1. According to some embodiments, the controller 241 may change the rectification current Irect by changing the operating current Io based on the regulator control signal DCctrl. As the rectification current Irect fluctuates due to the resistive impedance control circuit 243 and the controller 241, the load impedance Zload at the output terminal of the receiver LC circuit LC2 may fluctuate.

The load impedance measurement unit 246 may receive a plurality of rectification currents Irect and a plurality of rectification voltages Vrect corresponding to the plurality of rectification currents Irect, and measure a plurality of load impedances Zload corresponding to the plurality of rectification currents Irect based on the plurality of rectification currents Irect and the plurality of rectification voltages Vrect.

At time t3, the rectification current Irect may fluctuate from a first rectification current Irect1 to a second rectification current Irect2, and the rectifier circuit 242 may perform a rectification operation and generate a second rectification voltage Vrect2 corresponding to the second rectification current Irect2. In addition, the load impedance measurement unit 246 may measure a second load impedance Zload2 corresponding to the second rectification current Irect2 based on the second rectification current Irect2 and the second rectification voltage Vrect2.

At time t4, the rectification current Irect may fluctuate from the second rectification current Irect2 to a third rectification current Irect3, and the rectifier circuit 242 may perform a rectification operation and generate a third rectification voltage Vrect3 corresponding to the third rectification current Irect3. In addition, the load impedance measurement unit 246 may measure a third load impedance Zload3 corresponding to the third rectification current Irect3 based on the third rectification current Irect3 and the third rectification voltage Vrect3.

The first to third rectification voltages Vrect1 to Vrect3 measured from time t2 to time t4 and the first to third load impedances Zload1 to Zload3 respectively corresponding to the first to third rectification voltages Vrect1 to Vrect3 may be provided to the coupling coefficient estimator unit 247.

The second electronic device 20 controls the connection of the capacitor at the output terminal of the receiver LC circuit LC2 to generate reactance information (S150).

The modulation circuit 245 may control the connection between the third and fourth nodes n3, n4 and the modulation capacitor based on the second impedance control signal Ictrl2, and the magnitude of the rectification voltage Vrect may fluctuate in response to the control of the connection between the third and fourth nodes n3, n4 and the modulation capacitor.

The coupling coefficient estimator unit 247 may confirm the polarity of the total input reactance in the total input impedance Zrx, which is reactance information, based on the rectification voltage Vrect that fluctuates in response to the connection control for the modulation capacitor.

If the polarity of the total input reactance in the total input impedance Zrx is positive, the magnitude of the rectification voltage Vrect may increase as the capacitance of the modulation circuit 245 connected to the third and fourth nodes n3, n4 increases. If the reactance polarity of the total input impedance Zrx is negative, the magnitude of the rectification voltage Vrect may decrease as the capacitance of the modulation circuit 245 connected to the third and fourth nodes n3, n4 increases. In the description of step S160 below, the fluctuation tendency of the rectification voltage Vrect according to the reactance polarity of the total input impedance Zrx will be described.

At time t5, the rectification current Irect may fluctuate from the third rectification current Irect3 to the first rectification current Irect1, and the modulation capacitance Ccm for the modulation circuit 245 connected to the third and fourth nodes n3, n4 may fluctuate from a first modulation capacitance Ccm1 to a second modulation capacitance Ccm2. In response to the rectification current Irect being the first rectification current Irect1 and the modulation capacitance Ccm being the second modulation capacitance Ccm2, the rectifier circuit 242 may generate a first modulated rectification voltage Vrect1_cm corresponding to the first rectification current Irect1 and the second modulation capacitance Ccm2.

At time t6, the modulation capacitance Ccm for the modulation circuit 245 connected to the third and fourth nodes n3, n4 may fluctuate from the second modulation capacitance Ccm2 to the first modulation capacitance Ccm1. In response to the rectification current Irect being the first rectification current Irect1 and the modulation capacitance Ccm being the first modulation capacitance Ccm1, the rectifier circuit 242 may generate a first rectification voltage Vrect1 corresponding to the first rectification current Irect1 and the first modulation capacitance Ccm1.

The load impedance measurement unit 246 may confirm the polarity of the total input reactance in the total input impedance Zrx, which is reactance information, through a magnitude comparison of the first modulated rectification voltage Vrect1_cm and the first rectification voltage Vrect1.

The second electronic device 20 calculates the coupling coefficient k based on the plurality of load impedances Zload corresponding to the plurality of rectification currents Irect and the reactance information (S160).

Assuming that the modulation selection switch SWcm is open, the AC voltage signal V43 applied to the load impedance Zload may be derived as in Equation 5 below based on FIG. 5 and FIG. 6.

$$V43 = Vrect ( \frac{4}{π} δ ( ω - {ω}_{o} ) + … ) = \frac{Vp\_refl \times Zload}{Zp\_refl + Zs + Zload} \qquad ( Equation 5 )$$

In Equation 5, V43 is the AC voltage signal applied to the load impedance, Vrect is the magnitude of the rectification voltage output from the rectifier circuit in the power receiver device, ω₀ is the resonant angular frequency of the transmitter LC circuit and the receiver LC circuit, Vp_refl is the reflected voltage provided by the reflected power source as viewed from the power receiver device, Zload is the load impedance of the power receiver device as viewed from the power receiver device, Zp_refl is the reflected impedance as viewed from the power receiver device, and Zs is the receiving impedance for the receiver LC circuit in the power receiver device.

By substituting the mutually corresponding first to third rectification voltages Vrect1 to Vrect3 and first to third load impedances Zload1 to Zload3 into the rectification voltage and load impedance of Equation 5, they may be expressed as in Equations 6 to 8 below.

$$Vrect 1 ( \frac{4}{π} δ ( ω - {ω}_{o} ) + ⋯ ) = \frac{Vp\_refl \times Zload 1}{Zp\_refl + Zs + Zload 1} \qquad ( Equation 6 )$$

$$Vrect 2 ( \frac{4}{π} δ ( ω - {ω}_{o} ) + … ) = \frac{Vp\_refl \times Zload 2}{Zp\_refl + Zs + Zload 2} \qquad ( Equation 7 )$$

$$Vrect 3 ( \frac{4}{π} δ ( ω - {ω}_{o} ) + … ) = \frac{Vp\_refl \times Zload 3}{Zp\_refl + Zs + Zload 3} \qquad ( Equation 8 )$$

By dividing Equation 6 by Equation 7, a relational expression for the first rectification current Irect1 and the second rectification current Irect2, which is the current ratio I₁₂, may be derived as in Equation 9 below

$${I}_{12} = \frac{Irect 1}{Irect 2} = \frac{Zp\_refl + Zs + Zload 2}{Zp\_refl + Zs + Zload 1} \qquad ( Equation 9 )$$

By dividing Equation 6 by Equation 8, a relational expression for the first rectification current Irect1 and the third rectification current Irect3, which is the current ratio I₁₃, may be derived as in Equation 10 below.

$${I}_{13} = \frac{Irect 1}{Irect 3} = \frac{Zp\_refl + Zs + Zload 3}{Zp\_refl + Zs + Zload 1} \qquad ( Equation 10 )$$

Since the sum of the reflected impedance Zp_refl and the receiving impedance Zs is the total input impedance Zrx, each of Equation 9 and Equation 10 may be simplified to Equation 11 and Equation 12 below.

$${I}_{12} = \frac{Zrx + Zload 2}{Zrx + Zload 1} \qquad ( Equation 11 )$$

$${I}_{13} = \frac{Zrx + Zload 3}{Zrx + Zload 1} \qquad ( Equation 12 )$$

The total input impedance Zrx may be expressed as a total input resistance and a total input reactance as in Equation 13 below.

$$Zrx = Rrx + jXrx \qquad ( Equation 13 )$$

In Equation 13, Zrx is the total input impedance, Rrx is the total input resistance, which is the resistance component of the total input impedance, Xrx is the total input reactance, which is the reactance component of the total input impedance.

By performing a square operation on each of Equations 11 to 13 and then performing a polynomial operation on the total input resistance and the total input reactance, the total input resistance and the total input reactance may be expressed as in Equation 14 below.

$$Rrx = \frac{\begin{matrix}( {( Zload 2 )}^{2} - {( {I}_{12} )}^{2} {( Zload 1 )}^{2} ) ( {( {I}_{13} )}^{2} - 1 ) ) - \\ ( {( {I}_{12} )}^{2} - 1 ) ( {( Zload 3 )}^{2} - {( {I}_{13} )}^{2} {( Zload 1 )}^{2} )\end{matrix}}{\begin{matrix}( {( {I}_{12} )}^{2} - 1 ) ( 2 Zload 3 - 2 {( {I}_{13} )}^{2} Zload 1 ) - \\ ( {( {I}_{13} )}^{2} - 1 ) ( 2 Zload 2 - 2 {( {I}_{12} )}^{2} Zload 1 )\end{matrix}} . \\ Xrx = \pm \sqrt{\frac{{( Rrx + Zload 2 )}^{2} - {( {I}_{12} )}^{2} {( Rrx + Zload 1 )}^{2}}{( {( {I}_{12} )}^{2} - 1 )}} \qquad ( Equation 14 )$$

In Equation 14, Rrx is the total input resistance, which is the resistance component of the total input impedance Zrx, Xrx is the total input reactance, which is the reactance component of the total input impedance Zrx, I₁₂ is the ratio of the first rectification current Irect1 to the second rectification current Irect2, I₁₃ is the ratio of the first rectification current Irect1 to the third rectification current Irect3, Zload1 is the first load impedance Zload1, Zload2 is the second load impedance Zload2, and Zload3 is the third load impedance Zload3.

Since the reflected impedance Zp_refl may be expressed as the difference between the total input impedance Zrx and the receiving impedance Zs, the reflected resistance, which is the resistance component of the reflected impedance Zp_refl, and the reflected reactance, which is the reactance component of the reflected impedance Zp_refl, may be expressed as in Equation 15 below.

$$Rp\_refl = \frac{\begin{matrix}( {( Zload 2 )}^{2} - {( {I}_{12} )}^{2} {( Zload 1 )}^{2} ) ( {( {I}_{13} )}^{2} - 1 ) ) - \\ ( {( {I}_{12} )}^{2} - 1 ) ( {( Zload 3 )}^{2} - {( {I}_{13} )}^{2} {( Zload 1 )}^{2} )\end{matrix}}{\begin{matrix}( {( {I}_{12} )}^{2} - 1 ) ( 2 Zload 3 - 2 {( {I}_{13} )}^{2} Zload 1 ) - \\ ( {( {I}_{13} )}^{2} - 1 ) ( 2 Zload 2 - 2 {( {I}_{12} )}^{2} Zload 1 )\end{matrix}} - Rs , \\ Xp\_refl = \pm \sqrt{\frac{{( Rrx + Zload 2 )}^{2} - {( {I}_{12} )}^{2} {( Rrx + Zload 1 )}^{2}}{( {( {I}_{12} )}^{2} - 1 )}} - Xs \qquad ( Equation 15 )$$

In Equation 15, Rp_refl is the reflected resistance, which is the resistance component of the reflected impedance Zp_refl, Rs is the receiving resistance, which is the resistance component of the receiver LC circuit LC2, Xp_refl is the reflected reactance, which is the reactance component of the reflected impedance Zp_refl, and Xs is the receiving reactance, which is the reactance component of the receiver LC circuit LC2.

The total input resistance, which is the resistance component of the total input impedance Zrx, is always positive because it is based on the transmitter coil Lp and the receiver coil Ls, but the total input reactance, which is the reactance of the total input impedance Zrx, may be negative in a low frequency band, so the polarity of the total input reactance must be confirmed.

Assuming that the modulation selection switch SWcm is shorted, the AC voltage signal V43 applied to the load impedance Zload may be expressed as in Equation 16 below, based on FIG. 5 and FIG. 6.

$$V43 = Vrect ( \frac{4}{π} δ ( ω - {ω}_{o} ) + ⋯ ) = Vp\_refl \times \frac{Zload}{Zrx + ( 1 + \frac{Zrx}{Zcm} ) Zload} \qquad ( Equation 16 )$$

In Equation 16, V43 is the AC voltage signal applied to the load impedance, Vrect is the magnitude of the rectification voltage output from the rectifier circuit in the power receiver device, ω₀ is the resonant angular frequency of the transmitter LC circuit and the receiver LC circuit, Vp_refl is the reflected voltage provided by the reflected power source as viewed from the power receiver device, Zload is the load impedance of the power receiver device as viewed from the power receiver device, Zrx is the total input impedance as viewed from the power receiver device, and Zcm is the modulation impedance for the modulation circuit of the power receiver device.

By expressing the modulation impedance Zcm geometrically as −j|Zcm| using the fact that the modulation circuit 245 is implemented with a capacitor and expressing the total input impedance Zrx geometrically as |Zrx|e^{iθrx}, Equation 16 may be expressed as in Equation 17 below.

$$Vrect ( \frac{4}{π} δ ( ω - {ω}_{o} ) + ⋯ ) = Vp\_refl \times \frac{Zload}{Zrx + ( 1 + \vert \frac{Zrx}{Zcm} \vert ( - sin ( θ rx ) + j cos ( θ rx ) ) Zload} \qquad ( Equation 17 )$$

In Equation 17, θrx is the phase for the total input impedance Zrx, and the polarity is the reactance information for the total input impedance Zrx.

If the above θrx is 0 or more, the polarity of the total input reactance for the total input impedance Zrx may be positive. If the magnitude of the modulation capacitance for the modulation circuit 245 increases, the magnitude of the modulation impedance Zcm decreases, so if the polarity of the total input reactance is positive and the magnitude of the modulation capacitance increases, the denominator component on the right side of Equation 17 may decrease and the magnitude of the rectification voltage Vrect may increase.

Conversely, if the above θrx is less than 0, the polarity of the total input reactance for the total input impedance Zrx may be negative. If the magnitude of the modulation capacitance for the modulation circuit 245 increases, the magnitude of the modulation impedance Zcm decreases, so if the polarity of the total input reactance is negative and the magnitude of the modulation capacitance increases, the denominator component on the right side of Equation 17 may increase and the magnitude of the rectification voltage Vrect may decrease.

Therefore, the load impedance measurement unit 246 may confirm the polarity of the total input reactance in the total input impedance Zrx through a magnitude comparison of the first modulated rectification voltage Vrect1_cm and the first rectification voltage Vrect1. In response to the magnitude of the first modulated rectification voltage Vrect1_cm being greater than the magnitude of the first rectification voltage Vrect1, the load impedance measurement unit 246 may confirm that the polarity of the total input reactance in the total input impedance Zrx is positive. In response to the magnitude of the first modulated rectification voltage Vrect1_cm being smaller than the magnitude of the first rectification voltage Vrect1, the load impedance measurement unit 246 may confirm that the polarity of the total input reactance in the total input impedance Zrx is negative.

The load impedance measurement unit 246 may calculate the reflected impedance Zp_refl by applying the first to third rectification currents Irect1 to Irect3, the first to third load impedances Zload1 to Zload3 respectively corresponding to the first to third rectification currents Irect1 to Irect3, and the confirmed reactance information, which is the polarity of the total input reactance in the total input impedance Zrx, to Equation 15.

The load impedance measurement unit 246 may calculate the estimated coupling coefficient value k_est by applying the calculated reflected impedance Zp_refl to Equation 4.

Referring to FIG. 10 as an example, the rectification voltage Vrect fluctuates together as the rectification current Irect and the modulation capacitance Ccm fluctuate, but even under the same conditions, the value of the rectification voltage Vrect may differ corresponding to the coupling coefficient k between the coil of the first electronic device 10 and the receiver coil Ls of the second electronic device 20. The second rectification voltage Vrect2 between time t3 and time t4 when the coupling coefficient k is 0.9 may be different from the second rectification voltage Vrect2 between time t3 and time t4 when the coupling coefficient k is 0.7. In addition, the third rectification voltage Vrect3 between time t4 and time t5 when the coupling coefficient k is 0.9 may be different from the third rectification voltage Vrect3 between time t4 and time t5 when the coupling coefficient k is 0.7. In addition, the first modulated rectification voltage Vrect1_cm between time t5 and time t6 when the coupling coefficient k is 0.9 may be different from the first modulated rectification voltage Vrect1_cm between time t5 and time t6 when the coupling coefficient k is 0.7.

The load impedance measurement unit 246 may calculate the estimated coupling coefficient value k_est through the plurality of load impedances Zload1 to Zload3 and reactance information measured while changing the rectification current Irect and the modulation capacitance Ccm.

According to some embodiments, the second electronic device 20 may change the resistance component and the reactance component of the load impedance Zload through the resistive impedance control circuit 243 and the modulation circuit 245, measure the rectification voltage Vrect that fluctuates in response thereto, and calculate the estimated coupling coefficient value k_est between the coil of the first electronic device 10 and the receiver coil Ls of the second electronic device 20 based on the measured rectification voltage Vrect.

The controller 241 compares the estimated coupling coefficient value k_est with a predetermined threshold value TH (S170).

The controller 241 may receive the estimated coupling coefficient value k_est calculated by the load impedance measurement unit 246.

The controller 241 compares the estimated coupling coefficient value k_est with a predetermined threshold value TH, and may provide alignment feedback data FBD for the alignment between the transmitter coil of the first electronic device 10 and the receiver coil of the second electronic device 20 to the processor 21 according to the comparison result. The estimated coupling coefficient value k_est may be a predetermined real number less than or equal to 1. The predetermined threshold value TH may be determined to be a value closer to 1. For example, the predetermined threshold value TH may be 0.9. The predetermined threshold value TH may be stored in the memory 22.

In response to the estimated coupling coefficient value k_est being smaller than the predetermined threshold value TH, the processor 21 sends negative feedback on the alignment to the user interface 23 (S180).

In response to the estimated coupling coefficient value k_est being smaller than the predetermined threshold value TH, the controller 241 may send negative alignment feedback data FBD to the processor 21. The processor 21, in response to the negative alignment feedback data FBD, may provide negative feedback on the alignment to the user interface 23.

The user interface 23, in response to receiving the negative feedback on the alignment from the processor 21, may display that ‘the receiver coil Ls and the coil of the transmitter LC circuit LC1 are misaligned with each other’. For example, when the user interface 23 is a display, the processor 21 may cause the user interface 23 to display information advising the user of the misalignment between the receiver coil Ls and the coil of the transmitter LC circuit LC1.

Referring to FIG. 11 as an example, in response to receiving negative feedback on the alignment from the processor 21, the display 231 of the user interface 23 may display “MISALIGN” implying the meaning of ‘misalignment’, and the vibrator of the user interface 23 may perform a vibration operation to vibrate the second electronic device 20.

Through the operation of the user interface 23 as described above, the second electronic device 20 may make the user aware of the alignment state between the coils and may induce the user to adjust the alignment state between the first electronic device 10 and the second electronic device 20.

In response to the estimated coupling coefficient value k_est being smaller than the predetermined threshold value TH, the second electronic device 20 sends the estimated coupling coefficient value k_est to the first electronic device 10 (S190).

In response to the estimated coupling coefficient value k_est being smaller than the predetermined threshold value TH, the controller 241 may provide receiver data RD corresponding to the estimated coupling coefficient value k_est to the modulation circuit 245 so that a modulation operation for the estimated coupling coefficient value k_est is performed. The modulation circuit 245 may perform a modulation operation in response to the receiver data RD corresponding to the estimated coupling coefficient value k_est. In response to the modulation operation, the modulation capacitance of the modulation circuit 245 connected to the output terminal of the receiver LC circuit LC2 fluctuates, and the difference in the amplitude of the voltage applied from the transmitter LC circuit LC1 may be adjusted. The demodulation circuit 15 may demodulate the amplitude of the voltage applied to the coil of the transmitter LC circuit LC1 to generate a demodulated signal Vdemod, and the transmitter controller 16 may receive the receiver data RD corresponding to the estimated coupling coefficient value k_est based on the demodulated signal Vdemod.

In response to the estimated coupling coefficient value k_est being smaller than the predetermined threshold value TH, step S180, step S190, and steps S130 to S170 may be repeatedly performed.

Although step S180 is illustrated to precede step S190 in FIG. 8, it is not limited thereto, and according to an embodiment, step S190 may precede first, or step S180 and step S190 may be performed together.

In response to the estimated coupling coefficient value k_est being equal to or larger than the predetermined threshold value TH, the processor 21 sends positive feedback on the alignment to the user interface 23 (S200).

In response to the estimated coupling coefficient value k_est being equal to or larger than the predetermined threshold value TH, the controller 241 may send positive alignment feedback data FBD to the processor 21. The processor 21, in response to the positive alignment feedback data FBD, may provide positive feedback on the alignment to the user interface 23.

The user interface 23, in response to receiving the positive feedback on the alignment from the processor 21, may display that ‘the receiver coil Ls and the coil of the transmitter LC circuit LC1 are aligned with each other’. For example, in response to receiving positive feedback on the alignment from the processor 21, the display 231 of the user interface 23 may display “ALIGN” implying the meaning of ‘alignment’.

The second electronic device 20, through the performance of steps S130 to S160, may measure a plurality of load impedances Zload corresponding to a plurality of rectification currents Irect by changing the rectification current Irect, and calculate the estimated coupling coefficient value k_est between the receiver coil Ls and the coil of the transmitter LC circuit LC1 through the plurality of rectification currents Irect and the plurality of load impedances Zload. The second electronic device 20 may perform a display operation of the user interface 23 based on the estimated coupling coefficient value k_est through the performance of steps S110 to S200 to make the user aware of the alignment state between the coils. The second electronic device 20 may induce the user to adjust the alignment state between the first electronic device 10 and the second electronic device 20 without including a separate member such as a magnet for coil alignment.

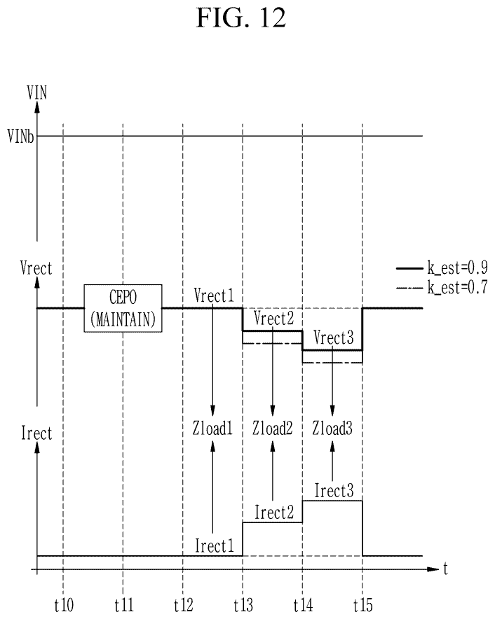

FIG. 12 is a timing diagram for explaining a method of operating an electronic device according to some embodiments.

Referring to FIG. 1, FIG. 2, FIG. 5, and FIG. 12, at time t10, the first electronic device 10 may generate a first power signal PS1 based on a b-th input voltage VINb, and the second electronic device 20 may receive a second power signal PS2 corresponding to the b-th input voltage VINb. The rectifier circuit 242 may perform a rectification operation on the second power signal PS2 corresponding to the b-th input voltage VINb, and generate a first rectification current Irect1 flowing to the rectification node (e.g., rectification node nr in FIG. 4) and generate a first rectification voltage Vrect1 applied to the rectification node (e.g., rectification node nr in FIG. 4).

At time t11, the modulation circuit 245 may perform a modulation operation based on the zeroth control error packet CEP0, and the second electronic device 20 may send the zeroth control error packet CEP0 to the first electronic device 10 through the modulation operation. In the modulation operation, the rectification voltage Vrect generated from the rectifier circuit 242 may fluctuate.

The zeroth control error packet CEP0 is a control error packet requesting the maintenance of the reception condition for the second power signal PS2, and for example, the second electronic device 20 may request the first electronic device 10 to maintain the input voltage VIN at the existing voltage, the b-th input voltage VINb, through the zeroth control error packet CEP0 in the process of calculating the estimated coupling coefficient value k_est. The transmitter controller 16 in the first electronic device 10 may provide a voltage control signal Vctrl to the power source 11 based on the zeroth control error packet CEP0 and maintain the input voltage VIN at the existing voltage, the b-th input voltage VINb.

At time t12, after the sending of the zeroth control error packet CEP0, the rectifier circuit 242 may perform a rectification operation on the second power signal PS2 and may generate a first rectification current Irect1 and a first rectification voltage Vrect1. In addition, the load impedance measurement unit 246 may measure a first load impedance Zload1 corresponding to the first rectification current Irect1 based on the first rectification current Irect1 and the first rectification voltage Vrect1.

At time t13, the rectification current Irect may fluctuate from a first rectification current Irect1 to a second rectification current Irect2, and the rectifier circuit 242 may perform a rectification operation and generate a second rectification voltage Vrect2 corresponding to the second rectification current Irect2. In addition, the load impedance measurement unit 246 may measure a second load impedance Zload2 corresponding to the second rectification current Irect2 based on the second rectification current Irect2 and the second rectification voltage Vrect2.

At time t14, the rectification current Irect may fluctuate from the second rectification current Irect2 to a third rectification current Irect3, and the rectifier circuit 242 may perform a rectification operation and generate a third rectification voltage Vrect3 corresponding to the third rectification current Irect3. In addition, the load impedance measurement unit 246 may measure a third load impedance Zload3 corresponding to the third rectification current Irect3, based on the third rectification current Irect3 and the third rectification voltage Vrect3.

The fluctuated first to third rectification currents Irect1 to Irect3, the measured first to third rectification voltages Vrect1 to Vrect3, and the first to third load impedances Zload1 to Zload3 respectively corresponding to the first to third rectification voltages Vrect1 to Vrect3 from time t12 to time t14 may be provided to the coupling coefficient estimator unit 247.

At time t15, the rectification current Irect may fluctuate from the third rectification current Irect3 to the first rectification current Irect1. In response to the rectification current Irect being the first rectification current Irect1, the rectifier circuit 242 may generate a first rectification voltage Vrect1 corresponding to the first rectification current Irect1.

The coupling coefficient estimator unit 247, assuming that the reactance polarity of the total input impedance Zrx is positive considering the frequency of the power signal defined in the Qi standard of the WPC, may calculate the reflected resistance, which is the resistance component of the reflected impedance Zp_refl, and the reflected reactance, which is the reactance component of the reflected impedance Zp_refl, as in Equation 18 below.

$$Rrx = \frac{\begin{matrix}( {( Zload 2 )}^{2} - {( {I}_{12} )}^{2} {( Zload 1 )}^{2} ) ( {( {I}_{13} )}^{2} - 1 ) ) - \\ ( {( {I}_{12} )}^{2} - 1 ) ( {( Zload 3 )}^{2} - {( {I}_{13} )}^{2} {( Zload 1 )}^{2} )\end{matrix}}{\begin{matrix}( {( {I}_{12} )}^{2} - 1 ) ( 2 Zload 3 - 2 {( {I}_{13} )}^{2} Zload 1 ) - \\ ( {( {I}_{13} )}^{2} - 1 ) ( 2 Zload 2 - 2 {( {I}_{12} )}^{2} Zload 1 )\end{matrix}} . \\ Rp\_refl = Rrx - Rs , \\ Xp\_refl = \sqrt{\frac{{( Rrx + Zload 2 )}^{2} - {( {I}_{12} )}^{2} {( Rrx + Zload 1 )}^{2}}{( {( {I}_{12} )}^{2} - 1 )}} - Xs \qquad ( Equation 18 )$$

In Equation 18, Rrx is the total input resistance, which is the resistance component of the total input impedance Zrx, Rp_refl is the reflected resistance, which is the resistance component of the reflected impedance Zp_refl, Xp_refl is the reflected reactance, which is the reactance component of the reflected impedance Zp_refl, I₁₂ is the ratio of the first rectification current Irect1 to the second rectification current Irect2, I₁₃ is the ratio of the first rectification current Irect1 to the third rectification current Irect3, Zload1 is the first load impedance Zload1, Zload2 is the second load impedance Zload2, Zload3 is the third load impedance Zload3, Rs is the receiving resistance, which is the resistance component of the receiver LC circuit LC2, Xs is the receiving reactance, which is the reactance component of the receiver LC circuit LC2.

The load impedance measurement unit 246 may calculate the estimated coupling coefficient value k_est by applying the calculated reflected impedance Zp_refl to Equation 4.

Referring to FIG. 12 as an example, the rectification voltage Vrect may fluctuate together as the rectification current Irect fluctuates, but even under the same conditions, the value may differ corresponding to the coupling coefficient k between the coil of the first electronic device 10 and the receiver coil Ls of the second electronic device 20. The second rectification voltage Vrect2 between time t13 and time t14 when the coupling coefficient k is 0.9 may be different from the second rectification voltage Vrect2 between time t13 and time t14 when the coupling coefficient k is 0.7. In addition, the third rectification voltage Vrect3 between time t14 and time t15 when the coupling coefficient k is 0.9 may be different from the third rectification voltage Vrect3 between time t14 and time t15 when the coupling coefficient k is 0.7.

The second electronic device 20 may easily estimate the coupling coefficient between the receiver coil Ls and the coil of the transmitter LC circuit LC1 according to the situation, such as the frequency of the power signal defined in the Qi standard of the WPC.

In addition, the second electronic device 20 may perform a display operation of the user interface 23 based on the calculated estimated coupling coefficient value k_est to make a user aware of the alignment state between the coils. The second electronic device 20 may induce the user to adjust the alignment state between the first electronic device 10 and the second electronic device 20 without including a separate member such as a magnet for coil alignment.

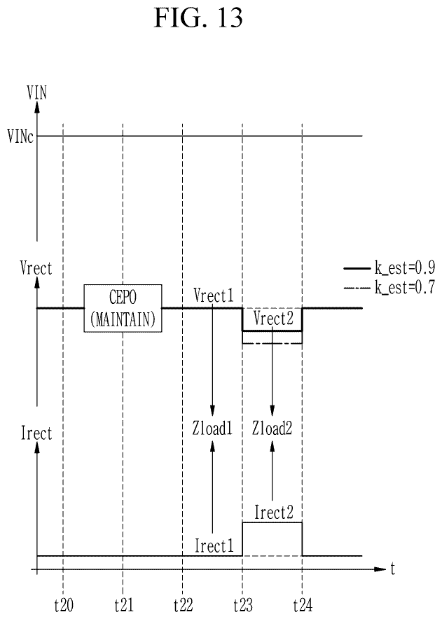

FIG. 13 is a timing diagram for explaining a method of operating an electronic device according to some example embodiments.

Referring to FIG. 1, FIG. 2, FIG. 5, and FIG. 13, at time t20, the first electronic device 10 may generate a first power signal PS1 based on a c-th input voltage VINc, and the second electronic device 20 may receive a second power signal PS2 corresponding to the c-th input voltage VINc. The rectifier circuit 242 may perform a rectification operation on the second power signal PS2 corresponding to the c-th input voltage VINc, and generate a first rectification current Irect1 flowing to the rectification node (e.g., rectification node nr in FIG. 4) and generate a first rectification voltage Vrect1 applied to the rectification node (rectification node nr in FIG. 4).

At time t21, the modulation circuit 245 may perform a modulation operation based on the zeroth control error packet CEP0, and the second electronic device 20 may send the zeroth control error packet CEP0 to the first electronic device 10 through the modulation operation. In the modulation operation, the rectification voltage Vrect generated from the rectifier circuit 242 may fluctuate.

The zeroth control error packet CEP0 is a control error packet requesting the maintenance of the reception condition for the second power signal PS2, and for example, the second electronic device 20 may request the first electronic device 10 to maintain the input voltage VIN at the existing voltage, the c-th input voltage VINc, through the zeroth control error packet CEP0 in the process of calculating the estimated coupling coefficient value k_est. The transmitter controller 16 in the first electronic device 10 may provide a voltage control signal Vctrl to the power source 11 based on the zeroth control error packet CEP0 and may maintain the input voltage VIN at the existing voltage, the c-th input voltage VINc.

At time t22, after the sending of the zeroth control error packet CEP0, the rectifier circuit 242 may perform a rectification operation on the second power signal PS2 and may generate a first rectification current Irect1 and a first rectification voltage Vrect1. In addition, the load impedance measurement unit 246 may measure a first load impedance Zload1 corresponding to the first rectification current Irect1, based on the first rectification current Irect1 and the first rectification voltage Vrect1.

At time t23, the rectification current Irect may fluctuate from a first rectification current Irect1 to a second rectification current Irect2, and the rectifier circuit 242 may perform a rectification operation and generate a second rectification voltage Vrect2 corresponding to the second rectification current Irect2. In addition, the load impedance measurement unit 246 may measure a second load impedance Zload2 corresponding to the second rectification current Irect2 based on the second rectification current Irect2 and the second rectification voltage Vrect2.

The first to second rectification currents Irect1, Irect2 the measured first and second rectification voltages Vrect1, Vrect2, and the first and second load impedances Zload1, Zload2 respectively corresponding to the first and second rectification voltages Vrect1, Vrect2 that fluctuated at time t22 and time t23, may be provided to the coupling coefficient estimator unit 247.

At time t24, the rectification current Irect may fluctuate from the second rectification current Irect2 to the first rectification current Irect1. In response to the rectification current Irect being the first rectification current Irect1, the rectifier circuit 242 may generate a first rectification voltage Vrect1 corresponding to the first rectification current Irect1.

If the frequency of the power signal is greater than a predetermined size (for example, if the frequency of the power signal is greater than 300 kHz), the reactance component of the total input impedance Zrx is significantly larger than the resistance component of the total input impedance Zrx, so the resistance component of the total input impedance Zrx may be ignored in circuit analysis. The coupling coefficient estimator unit 247 may calculate the reflected impedance Zp_refl as in Equation 19 below.

$$Zp\_refl = j ( \sqrt{\frac{{( Zload 2 )}^{2} - {( {I}_{12} )}^{2} {( Zload 1 )}^{2}}{( {( {I}_{12} )}^{2} - 1 )}} - Xs ) \qquad ( Equation 19 )$$

In Equation 18, Zp_refl is the reflected impedance Zp_refl, I₁₂ is the ratio of the first rectification current Irect1 to the second rectification current Irect2, Zload1 is the first load impedance Zload1, Zload2 is the second load impedance Zload2, Xs is the receiving reactance, which is the reactance component of the receiver LC circuit LC2.

The load impedance measurement unit 246 may calculate the estimated coupling coefficient value k_est by applying the calculated reflected impedance Zp_refl to Equation 4.

Referring to FIG. 13 as an example, the rectification voltage Vrect may fluctuate together as the rectification current Irect fluctuates, but even under the same conditions, the value of the rectification voltage Vrect may differ corresponding to the coupling coefficient k between the coil of the first electronic device 10 and the receiver coil Ls of the second electronic device 20. The second rectification voltage Vrect2 between time t23 and time t24 when the coupling coefficient k is 0.9 may be different from the second rectification voltage Vrect2 between time t23 and time t24 when the coupling coefficient k is 0.7.

The second electronic device 20 may easily estimate the coupling coefficient between the receiver coil Ls and the coil of the transmitter LC circuit LC1 according to the situation, such as when the frequency of the power signal is above a certain frequency.

In addition, the second electronic device 20 may perform a display operation of the user interface 23 based on the calculated estimated coupling coefficient value k_est to make a user aware of the alignment state between the coils. The second electronic device 20 may induce the user to adjust the alignment state between the first electronic device 10 and the second electronic device 20 without including a separate member such as a magnet for coil alignment.

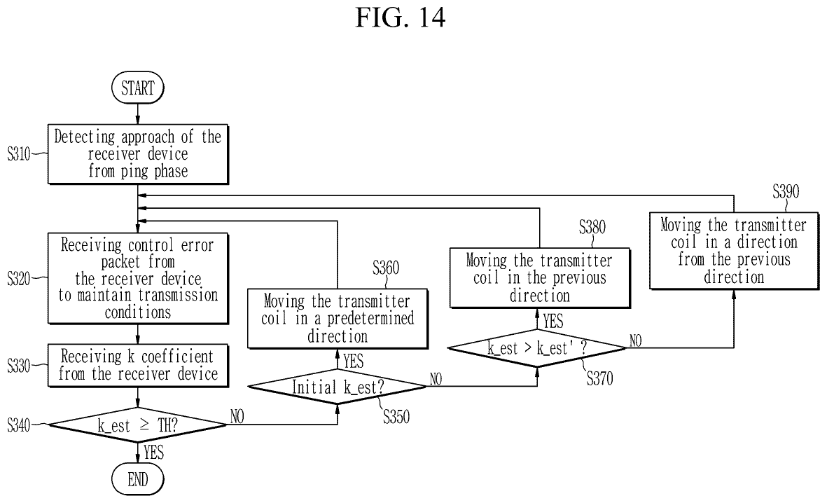

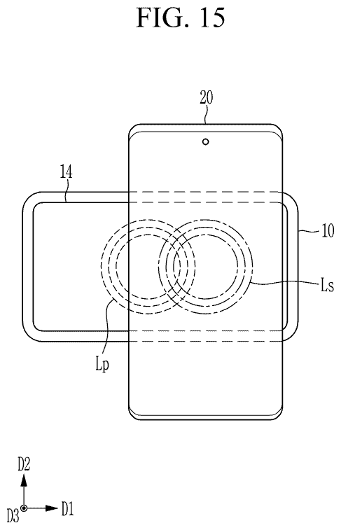

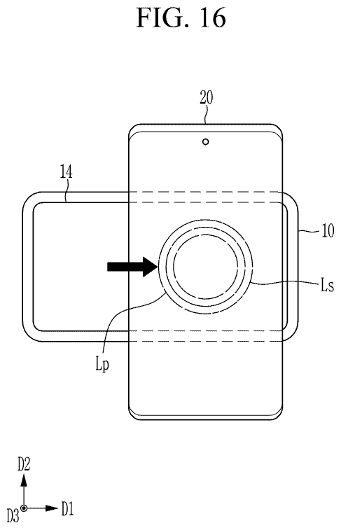

FIG. 14 is a flowchart illustrating a method of operating an electronic device according to some example embodiments. FIG. 15 to FIG. 16 are drawings for explaining a method of operating an electronic device according to some example embodiments.

Referring to FIG. 1, FIG. 2, and FIG. 14, the first electronic device 10 detects the second electronic device 20, which is a power receiver device, from the ping phase (S310).

Referring additionally to FIG. 15, the first electronic device 10, which is a power transmitter device, may be disposed adjacent to the second electronic device 20. The second electronic device 20 may be mounted on the outer surface of the first electronic device 10, and the receiver coil Ls of the second electronic device 20 and the coil of the first electronic device 10 may be misaligned with each other in a first direction D1.

The first electronic device 10 may check whether the adjacently disposed second electronic device 20 is included within the operating volume in the ping phase. According to some embodiments, the first electronic device 10 may use an analog ping, apply NFC tag protection, or check for the presence of FOD.

If the first electronic device 10 confirms that the second electronic device 20 is included within the operating volume, the first electronic device 10 may provide a digital ping in the ping phase to request a signal strength data packet.

The second electronic device 20 may provide a signal strength data packet to the first electronic device 10 in response to the digital ping of the first electronic device 10 in the ping phase and detect the first electronic device 10.

The ping phase in step S310 may correspond to the ping phase defined in the Qi standard of the WPC and may correspond to the ping phase in step S110 of FIG. 8.

The first electronic device 10 receives the control error packet of the second electronic device 20 and maintains a transmission condition for the power signal transmitted to the second electronic device 20 (S320).

After the ping phase in step S310, through a configuration phase and a negotiation phase, the first electronic device 10 may transmit a first power signal PS1 to the second electronic device 20. Through the transmission operation of the first power signal PS1, the second electronic device 20 may receive a second power signal PS2 corresponding to the first power signal PS1.

In correspondence with the reception of the second power signal PS2, the second electronic device 20 may generate a zeroth control error packet requesting the maintenance of the reception condition for the second power signal PS2. The zeroth control error packet CEP0 may be one of the control error packets defined in the Qi standard of the WPC, and the transmitter controller 16 may receive the zeroth control error packet CEP0 through the demodulation circuit 15. For example, the second electronic device 20 may request the first electronic device 10 to maintain the input voltage VIN or maintain the frequency for the first power signal PS1 through the zeroth control error packet CEP0 in the process of estimating the coupling coefficient. In response to receiving the zeroth control error packet CEP0, the first electronic device 10 may maintain the input voltage VIN and transmit the first power signal PS1 based on the maintained input voltage VIN, and the frequency of the first power signal PS1 may be maintained.

The step of receiving the control error packet CEP0 in step S320 may correspond to the step of sending the control error packet CEP0 in step S130 of FIG. 8.

The first electronic device 10 receives the estimated coupling coefficient value k_est calculated by the second electronic device 20 (S330).

The second electronic device 20 may perform a modulation operation in response to receiver data RD corresponding to the estimated coupling coefficient value k_est. In response to the modulation operation, the modulation capacitance of the modulation circuit 245 connected to the output terminal of the receiver LC circuit LC2 may fluctuate, and the difference in the amplitude of the voltage applied from the transmitter LC circuit LC1 may be adjusted.

The demodulation circuit 15 may demodulate the amplitude of the voltage applied to the coil of the transmitter LC circuit LC1 to generate a demodulated signal Vdemod, and the transmitter controller 16 may receive the estimated coupling coefficient value k_est in correspondence with the maintained transmission condition based on the demodulated signal Vdemod.

The step of receiving the estimated coupling coefficient value k_est in step S330 may correspond to the step of sending the estimated coupling coefficient value k_est in step S190 of FIG. 8.

The transmitter controller 16 compares the estimated coupling coefficient value k_est with a predetermined threshold value TH (S340).

The transmitter controller 16 may compare the estimated coupling coefficient value k_est with a predetermined threshold value TH, and provide a location control signal Lctrl to the pad unit 14 according to the comparison result. The estimated coupling coefficient value k_est may be a predetermined real number less than or equal to 1.

In response to the estimated coupling coefficient value k_est being smaller than the predetermined threshold value TH, the transmitter controller 16 checks whether the received estimated coupling coefficient value k_est is an initial value (S350).

In response to the estimated coupling coefficient value k_est being the initial value, the transmitter controller 16 moves the transmitter coil Lp in a predetermined direction (S360).

In response to the estimated coupling coefficient value k_est being the initial value, the transmitter controller 16 may provide a location control signal Lctrl to the pad unit 14, and the pad unit 14 may move the coil of the transmitter LC circuit LC1 in a predetermined direction.

In response to the estimated coupling coefficient value k_est not being the initial value, the transmitter controller 16 compares the previous estimated coupling coefficient value k_est′ with the estimated coupling coefficient value k_est (S370).

If the estimated coupling coefficient value k_est is not the initial value, the transmitter controller 16 may receive the previous estimated coupling coefficient value k_est′ based on the demodulated signal Vdemod before receiving the estimated coupling coefficient value k_est.

In response to the estimated coupling coefficient value k_est being larger than the previous estimated coupling coefficient value k_est′, the transmitter controller 16 moves the transmitter coil Lp in the previously moved direction (S380).

In response to the estimated coupling coefficient value k_est being larger than the previous estimated coupling coefficient value k_est′, the transmitter controller 16 may provide a location control signal Lctrl to the pad unit 14, and the pad unit 14 may move the coil of the transmitter LC circuit LC1 in the previously moved direction.

In response to the estimated coupling coefficient value k_est being smaller than the previous estimated coupling coefficient value k_est′, the transmitter controller 16 moves the transmitter coil Lp in a direction different from the previously moved direction (S390).

In response to the estimated coupling coefficient value k_est being smaller than the previous estimated coupling coefficient value k_est′, the transmitter controller 16 may provide a location control signal Lctrl to the pad unit 14, and the pad unit 14 may move the coil of the transmitter LC circuit LC1 in a direction different from the previously moved direction.

In response to the estimated coupling coefficient value k_est being smaller than the predetermined threshold value TH, steps S350 to S390 and steps S320 to S340 may be repeatedly performed.

Through the repeated performance of steps S350 to S390 and steps S320 to S340, the coil of the transmitter LC circuit LC1 may move within the housing of the pad unit 14 in a direction in which the coupling coefficient k with the receiver coil Ls increases. Referring to FIG. 15 and FIG. 16 as an example, as the second electronic device 20 is mounted on the first electronic device 10, the transmitter coil Lp is disposed in a state misaligned with the receiver coil Ls in a first direction D1, but through the repeated performance of steps S350 to S390 and steps S320 to S340, the transmitter coil Lp may move in the first direction D1 within the housing of the pad unit 14. Through the movement of the transmitter coil Lp, the transmitter coil Lp and the receiver coil Ls are aligned with each other, and the coupling coefficient k between the transmitter coil Lp and the receiver coil Ls may be increased.

The first electronic device 10, which is a power transmitter device, may repeatedly receive the estimated coupling coefficient value k_est from the second electronic device 20, and based on this, move the coil in a direction in which the coupling coefficient k between the coil of the first electronic device 10 and the coil of the second electronic device 20 increases. Through the movement of the coil in the first electronic device 10, in the wireless charging system 1, the second electronic device 20, which is a power receiver device, may cost-effectively induce optimal alignment between the coils without including a separate member such as a magnet for alignment.

Although the embodiments of the present disclosure have been described in detail above, the scope of rights of the present disclosure is not limited thereto, and various modifications and improvements by those skilled in the art using the basic concept of the present disclosure defined in the following claims also belong to the scope of rights of the present disclosure.

1. An electronic device comprising:
an LC circuit including a coil and a first capacitor, and configured to receive a power signal through induction of the coil;
a rectifier circuit configured to generate a DC voltage and a DC current based on the power signal;
a regulator circuit configured to perform a conversion operation based on the DC voltage and the DC current to generate an output voltage;
an impedance control circuit disposed between the rectifier circuit and the regulator circuit, and configured to perform an operation of changing the DC current; and
a coupling coefficient estimator configured to calculate an estimated coupling coefficient value between the coil and an external coil, based on the DC current and a load impedance corresponding to the DC current.

2. The electronic device of claim 1,
wherein the rectifier circuit is configured to apply the DC voltage to a rectification node and output the DC current to the rectification node,
wherein the regulator circuit is connected to the rectification node and configured to receive an operating current from the rectification node, and
wherein the impedance control circuit is connected to the rectification node and configured to receive an impedance adjustment current from the rectification node.

3. The electronic device of claim 2,
wherein the impedance control circuit includes a variable current source, one end of which is connected to the rectification node and the other end of which is grounded, and which is configured to control the impedance adjustment current.

4. The electronic device of claim 2,
wherein the impedance control circuit includes a variable resistor, one end of which is connected to the rectification node and the other end of which is grounded, and a resistance value of which is configured to be adjusted.

5. The electronic device of claim 2, further comprising:
a controller configured to control an amount of the operating current.

6. The electronic device of claim 1, further comprising:
a load impedance measurement unit configured to measure the load impedance at an output terminal of the LC circuit, based on the DC voltage and the DC current.

7. The electronic device of claim 6,
wherein the DC current includes a first DC current, a second DC current, and a third DC current having different magnitudes from each other,
wherein the DC voltage includes a first DC voltage, a second DC voltage, and a third DC voltage output from the rectifier circuit and corresponding to the first DC current, the second DC current, and the third DC current, respectively,
wherein the load impedance includes a first load impedance measured based on the first DC current and the first DC voltage, a second load impedance measured based on the second DC current and the second DC voltage, and a third load impedance measured based on the third DC current and the third DC voltage, and
wherein the estimated coupling coefficient value is calculated based on the first DC current to the third DC current and the first load impedance to the third load impedance.

8. The electronic device of claim 7, further comprising:
a modulation circuit configured to control a connection between the output terminal of the LC circuit and a second capacitor,
wherein the load impedance measurement unit is configured to confirm reactance information for a total input impedance in the LC circuit based on a magnitude of the DC voltage that fluctuates according to the connection of the second capacitor, and
wherein the coupling coefficient estimator is further configured to calculate the estimated coupling coefficient value based on the reactance information, the first DC current to the third DC current, and the first load impedance to the third load impedance.

9. The electronic device of claim 6,
wherein the DC current includes a first DC current and a second DC current having different magnitudes from each other,
wherein the DC voltage includes a first DC voltage and a second DC voltage output from the rectifier circuit and corresponding to the first DC current and the second DC current, respectively,
wherein the load impedance includes a first load impedance measured based on the first DC current and the first DC voltage and a second load impedance measured based on the second DC current and the second DC voltage, and
wherein the estimated coupling coefficient value is calculated based on the first DC current, the second DC current, the first load impedance, and the second load impedance.

10. The electronic device of claim 1, further comprising:
a user interface configured to display information implying misalignment between the coil and the external coil in response to the estimated coupling coefficient value being smaller than a predetermined threshold value.

11. The electronic device of claim 1,
wherein a magnitude of the power signal is maintained while the impedance control circuit performs the operation of changing the DC current.

12. A method of operating an electronic device, comprising:
detecting an approach of an external electronic device based on a ping phase;
performing a rectification operation on a power signal received from the external electronic device to generate a DC current flowing to a rectification node of the electronic device and a DC voltage applied to the rectification node;
sending a control error packet to the external electronic device to maintain a reception condition for the power signal received by an LC circuit of the electronic device from the external electronic device;
changing the DC current to measure a plurality of load impedances at an output terminal of the LC circuit;
calculating an estimated coupling coefficient value between an external coil in the external electronic device and an internal coil in the LC circuit, based on the plurality of load impedances;
comparing the estimated coupling coefficient value with a threshold value; and
sending negative feedback about an alignment between the external coil and the internal coil to a user interface of the electronic device in response to the estimated coupling coefficient value being smaller than the threshold value.

13. The method of operating the electronic device of claim 12,
wherein the changing the DC current to measure the plurality of load impedances includes controlling an impedance adjustment current flowing from the rectification node.

14. The method of operating the electronic device of claim 13,
wherein the DC current includes a first DC current, a second DC current, and a third DC current generated according to the controlling of the impedance adjustment current,
wherein the DC voltage includes a first DC voltage, a second DC voltage, and a third DC voltage applied to the rectification node and corresponding to the first DC current, the second DC current, and the third DC current, respectively,
wherein the plurality of load impedances include a first load impedance measured based on the first DC current and the first DC voltage, a second load impedance measured based on the second DC current and the second DC voltage, and a third load impedance measured based on the third DC current and the third DC voltage, and
wherein the estimated coupling coefficient value is calculated based on the first DC current to the third DC current and the first load impedance to the third load impedance.

15. The method of operating the electronic device of claim 12, further comprising:
controlling a connection between the output terminal of the LC circuit and a capacitor to generate reactance information for a total input impedance of the LC circuit,
wherein the estimated coupling coefficient value is calculated based on the plurality of load impedances and the reactance information.

16. The method of operating the electronic device of claim 12, further comprising:
in response to the estimated coupling coefficient value being smaller than the threshold value, sending the estimated coupling coefficient value to the external electronic device.

17. A wireless charging system comprising:
a first electronic device including a power source configured to provide an input voltage, a first LC circuit including a first coil and a first capacitor and configured to transmit a first power signal corresponding to the input voltage through induction of the first coil, and a demodulation circuit configured to generate a demodulated signal including a data packet for the first power signal; and
a second electronic device including a second LC circuit including a second coil and a second capacitor and configured to receive a second power signal corresponding to the first power signal through mutual induction of the first coil and the second coil, a rectifier circuit configured to generate a DC voltage and a DC current based on the second power signal, an impedance control circuit configured to perform an operation of changing the DC current, a controller configured to generate a control error packet requesting maintenance of the input voltage before the operation of changing the DC current, and a modulation circuit configured to perform a modulation operation on the control error packet using the second power signal.

18. The wireless charging system of claim 17,
wherein the second electronic device further includes a coupling coefficient estimator configured to calculate an estimated coupling coefficient value between the first coil and the second coil based on the DC current and a load impedance corresponding to the DC current.

19. The wireless charging system of claim 18,
wherein the second electronic device further includes a load impedance measurement unit configured to measure a load impedance at an output terminal of the second LC circuit based on the DC voltage and the DC current,
wherein the DC current includes a first DC current, a second DC current, and a third DC current having different magnitudes from each other,
wherein the load impedance is measured in accordance with the operation of changing the DC current and includes a first load impedance, a second load impedance, and a third load impedance corresponding to the first DC current, the second DC current, and the third DC current, respectively, and
wherein while the input voltage is maintained, the coupling coefficient estimator is configured to receive the first load impedance to the third load impedance.

20. The wireless charging system of claim 17,
wherein the modulation circuit is configured to control a connection between an output terminal of the second LC circuit and a modulation capacitor in the modulation operation to adjust an amplitude of the second power signal.

21.-22. (canceled)
